(19) United States
(12) Patent Application Publication
(10) Pub. No.: US 2023/0289610 A1
(43) Pub. Date: Sep. 14, 2023

(54) ARTIFICIAL INTELLIGENCE BASED METHODS AND SYSTEMS FOR UNSUPERVISED REPRESENTATION LEARNING FOR BIPARTITE GRAPHS

(71) Applicant: MASTERCARD INTERNATIONAL INCORPORATED, Purchase, NY (US)

(72) Inventors: Sangam Verma, Bangalore (IN); Pranav Poduval, Noida (IN); Karamjit Singh, Gurugram (IN); Tanmoy Bhowmik, Bangalore (IN)

(21) Appl. No.: 18/180,802

(22) Filed: Mar. 8, 2023

(30) Foreign Application Priority Data
Mar. 9, 2022 (IN) 202241012724

(51) Int. Cl. G06N 3/088; G06N 3/04

(52) U.S. Cl. CPC G06N 3/088; G06N 3/04

(57) ABSTRACT

Embodiments provide methods and systems for unsupervised representation learning for bipartite graphs. Method performed by server system includes accessing historical transaction data from database. Method includes generating a bipartite graph based on historical transaction data. Bipartite graph represents a computer-based graph representation of a plurality of cardholders as first nodes and a plurality of merchants as second nodes and payment transactions between first nodes and second nodes as edges. Method includes sampling direct neighbor nodes and skip neighbor nodes associated with a node based on neighborhood sampling method and executing direct neighborhood aggregation method and skip neighborhood aggregation method to obtain direct neighborhood embedding and skip neighborhood embedding associated with node, respectively. Method includes optimizing combination of direct and skip neighborhood embeddings for obtaining final node representation associated with the node and executing graph context prediction tasks based on final node representations of first nodes and second nodes.

### TECHNICAL FIELD

The present disclosure relates to node representation learning systems and, more particularly to, electronic methods and complex processing systems for unsupervised representation learning for bipartite graphs to perform a plurality of graph context prediction tasks.

### BACKGROUND

A network graph represents a large network of relationships between various entities. Generally, the network graph contains a set of nodes and a set of edges. In addition, the nodes may represent entities that belong to the real world and the edges may represent a relationship between the entities. Many such real-world network graphs are inherently bipartite. Generally, a bipartite graph is a graph whose vertices can be divided into two independent and disjoint sets U and V, such that every edge connects a vertex in U to a vertex in V. More specifically, the nodes of the bipartite graph can be divided into two independent and disjoint partitions/sets/domains, such that an edge can connect nodes from one partition to another. Such bipartite graphs are used to represent data relationships between two different types of entities in various domains, such as payment networks (for example, user-merchant bipartite graph), e-commerce (for example, user-product bipartite graph), academics (for example, author-research paper bipartite graph), and the like. For example, a bipartite graph may be used to represent relationships as edges (e.g., payment transactions) between a first set of nodes (e.g., cardholders) and a second set of nodes (e.g., merchants).

To extract effective information from any graph, learning representations (e.g., embeddings) of nodes is an important and ubiquitous task. In general, representation learning refers to the ability of learning complex relations between the different entities of the bipartite graph from a high-dimensional graph structure to a low dimensional dense vector (i.e., embeddings). The learned representations (i.e., embeddings) may further be used to perform tasks such as link prediction, analysis, and so on. However, to extract effective information from the bipartite graph, there are a few limitations in the existing approaches because of the heterogeneous nature of the bipartite graph.

The bipartite graphs generally have a high variance in nodes and edges. For example, in a user-product e-commerce bipartite graph, the number of nodes for users is very high in scale as compared to the number of nodes for the products. Similarly, there can be a variance in the degree of the nodes as well. For example, some popular or common products may be purchased by most users.

Additionally, for the bipartite graphs, learning needs to be performed from nodes belonging to dissimilar sets/domains/partitions and therefore, the nodes belonging to different partitions have different feature sets. For example, in a user-product graph, the user may have user-specific features (e.g., age, gender, etc.) and the product may have product-specific features (e.g., brand, category, etc.). Further, the nodes of one partition cannot directly be connected to the nodes of the same partition, (for example, there are no direct edges between user-user nodes or the product-product nodes), and thereby, the learning may only be performed from nodes of the other partition. Furthermore, the nodes of varying types are influenced differently by the two different kinds of nodes in the bipartite graph (for example, a most bought product on an e-commerce platform may not be as influenced by the user who bought it, as a newly listed product).

In view of the above discussion, there exists a technological need for an unsupervised representation learning method for bipartite graphs.

### SUMMARY

Various embodiments of the present disclosure provide methods and systems for unsupervised representation learning for bipartite graphs.

In an embodiment, a computer-implemented method is disclosed. The method includes accessing, by a server system, historical interaction data including a plurality of interactions from a database. In addition, each interaction is associated with at least one entity of a first set of entities and one entity of a second set of entities. The method further includes generating, by the server system, a bipartite graph based, at least in part, on the historical interaction data. The bipartite graph represents a computer-based graph representation of the first set of entities as first nodes and the second set of entities as second nodes and interactions between the first nodes and the second nodes as edges. Furthermore, the method includes determining, by the server system, final node representations of the first nodes and the second nodes based, at least in part, on a bipartite graph neural network (BipGNN) model. The final node representations are determined by executing a plurality of operations for each node in graph traversal manner. The plurality of operations include sampling, by the server system, direct neighbor nodes and skip neighbor nodes associated with the node based, at least in part, on a neighborhood sampling method. The plurality of operations includes executing direct neighborhood aggregation method and skip neighborhood aggregation method to obtain direct neighborhood embedding and skip neighborhood embedding associated with the node, respectively. The plurality of operations further includes optimizing, by the server system, a combination of the direct and skip neighborhood embeddings for obtaining a final node representation associated with the node based, at least in part, on a neural network model. Moreover, the method includes executing at least one of a plurality of graph context prediction tasks based, at least in part, on the final node representations of the first nodes and the second nodes.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1A illustrates an exemplary representation of an environment related to at least some embodiments of the present disclosure;

FIG. 1B illustrates another exemplary representation of an environment related to at least some embodiments of the present disclosure;

FIG. 2 illustrates a simplified block diagram of a server system, in accordance with an embodiment of the present disclosure;

FIGS. 3A-3C depict example representations of a bipartite graph, in accordance with an embodiment of the present disclosure;

FIG. 4A is a block diagram representation of BipGNN model, in accordance with an embodiment of the present disclosure;

FIG. 4B is a block diagram representation of an attention module for combining direct neighborhood embedding and skip neighborhood embedding of a node, in accordance with an embodiment of the present disclosure;

FIGS. 5A-5C show example representations of practical applications of BipGNN model to perform a plurality of graph context prediction tasks, in accordance with embodiments of the present disclosure;

FIG. 6 represents a flow chart of a method for unsupervised representation learning for a bipartite graph, in accordance with an embodiment of the present disclosure;

FIG. 7 represents a flow chart of a method for unsupervised representation learning for a bipartite graph including a plurality of cardholders and a plurality of merchants, in accordance with an embodiment of the present disclosure;

FIG. 8 shows a table including comparative results of the performance of the BipGNN model and the other comparative algorithms on the above-stated plurality of graph context prediction tasks; and

FIG. 9 illustrates a flow diagram depicting a method for unsupervised representation learning for the bipartite graph, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “payment network”, used herein, refers to a network or collection of systems used for the transfer of funds through the use of cash substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by such as Mastercard®.

The term “merchant”, used throughout the description generally refers to a seller, a retailer, a purchase location, an organization, or any other entity that is in the business of selling goods or providing services, and it can refer to either a single business location or a chain of business locations of the same entity.

The terms “cardholder”, “user”, and “customer” are used interchangeably throughout the description and refer to a person who holds a credit or a debit card that will be used by a merchant to perform a payment transaction.

The terms “embeddings” and “vector representations” are used interchangeably throughout the description and refer to a low-dimensional state or space in which high-dimensional vectors can be translated. More specifically, embeddings make it easier to perform machine learning analysis on high-dimensional vector formats. In some embodiments, vector representations can include vectors that represent nodes from graph data in a vector space. In some embodiments, vector representations can include embeddings.

Overview

Various embodiments of the present disclosure provide methods, systems electronic devices, and computer program products for unsupervised representation learning for bipartite graphs. More specifically, embodiments of the present disclosure disclose a method for learning node representations (i.e., embeddings) for both direct neighbor nodes and skip neighbor nodes of a root node in a bipartite graph.

As noted above, bipartite graphs have a few limitations or drawbacks: (a) Bipartite graphs have a high variance in nodes and edges, and (b) In bipartite graphs, learning of representations (i.e., embeddings) needs to be performed from nodes of dissimilar domains. For example, in a bipartite graph, edges may represent relationships or interactions between entities belonging to a first set of nodes (e.g., users, cardholders, etc.) and entities belonging to a second set of nodes (e.g., movies, merchants, etc.). In addition, no relationship may exist between any two entities that belong to the same set of nodes. The entities that belong to a first set of nodes may be completely different from the entities that belong to a second set of nodes in the bipartite graph. Hence, there is a need for a mechanism to feed information from both the same and opposite node types.

In general, representation learning on graphs involves aggregating information from a node's immediate neighbors and training it in either a semi-supervised manner or an unsupervised manner to learn the node's embedding. Most existing graph representation learning approaches explicitly use self-node features as one of the inputs, which lead to a high correlation in information between the learned embeddings and self-node features and limits the performance boost offered by these embeddings for downstream tasks since both self-node features and the learnt embedding essentially carry the same information.

To overcome such problems or limitations, the present disclosure describes a server system that is configured to perform unsupervised representation learning for bipartite graphs. More specifically, the server system is configured to execute a bipartite graph neural network (BipGNN) model to learn node representations for the bipartite graphs with an unsupervised learning approach. Embodiments of the present disclosure disclose a bipartite graph neural network (BipGNN) model to learn node representations for bipartite graphs that explicitly capture information of neighboring nodes and implicitly capture self-node features.

At least one of the technical problems addressed by the present disclosure includes representation learning for the bipartite graphs based on embeddings of both direct neighbors as well as one-hop/skip neighbors of a root node of the bipartite graph. In addition, the present disclosure uses various aggregation blocks for capturing information (i.e., learning embeddings) from the direct neighbors as well as the skip neighbors of the root node. Further, the importance of the learned embeddings is determined based on an attention mechanism. The present disclosure describes learning hidden information or hidden representations that explicitly captures information from the node's neighborhood features along with implicitly retaining information from self-features of the node. Moreover, the present disclosure talks about a dual loss function based on a graph structural loss and hidden information maximization loss. In other words, the dual loss function captures the topological information of the graph and also enriches the embeddings by maximizing the mutual information. This is achieved by combining a graph structural loss and a mutual information (MI) maximization loss between the node embeddings learned from the neighborhood nodes and self-node features. The BipGNN model is trained in an unsupervised manner so that the embeddings are task agnostic and can be used for multiple downstream tasks.

In one embodiment, the server system includes at least a processor and a memory. In one non-limiting example, the server system is a payment server. The server system is configured to access historical interaction data including a plurality of interactions from a database. In addition, each interaction is associated with at least one entity of a first set of entities and one entity of a second set of entities. In one example, the first set of entities may represent cardholders, users, authors, and the like. The second set of entities may represent merchants, products, research papers, and the like. The interaction data may further represent payment transactions performed between the cardholders and the merchants, product purchases between the users and the products, connections depicting ownership between the authors and the books, and the like. In one embodiment, the historical interaction data accessed from the database may include data of payment transactions performed between a plurality of cardholders and a plurality of merchants over a time period (e.g., 1 month, 3 months, 2 years, 5 years, etc.).

The server system is configured to generate a bipartite graph based, at least in part, on the historical interaction data. The bipartite graph represents a computer-based graph representation of the first set of entities as first nodes and the second set of entities as second nodes and interactions between the first nodes and the second nodes as edges. In one embodiment, the first nodes represent a plurality of cardholders, and the second nodes represent a plurality of merchants. In addition, the edges represent payment transactions performed between the plurality of cardholders and the plurality of merchants.

More specifically, each cardholder of the plurality of cardholders is represented as a node in the first nodes. Similarly, each merchant of the plurality of merchants is represented as a node in the second nodes. In one embodiment, the first nodes are disjoint and independent from the second nodes. In addition, each edge represents a payment transaction performed between the cardholder and the merchant. In one embodiment, the server system is configured to generate a plurality of node feature vectors for each of the first nodes and the second nodes based, at least in part, on the historical interaction data.

The server system is configured to determine node representations for each node of the first nodes and the second nodes. More specifically, the server system is configured to determine first node representations of the first nodes and second node representations of the second node based, at least in part, on the bipartite graph neural network (BipGNN) model. In one embodiment, the BipGNN model may include a plurality of graph neural networks. In general, GNN is a class of deep learning methods used for processing data represented by graph data structures.

To determine the first node representations of the first nodes and the second nodes representations of the second nodes, the server system is configured to perform a plurality of operations corresponding to each node of the first nodes and the second nodes. Initially, the server system is configured to sample direct neighbor nodes and one-hop/skip neighbor nodes associated with the node based, at least in part, on a neighborhood sampling method. In one embodiment, the neighborhood sampling method defines a probability function for calculating the probability of sampling a node ‘n’ for a root node ‘m’. The probability function is proportional to the strength of weighted edge (i.e., connection) between the node ‘n’ and the root node ‘m’ divided by the degree of the node ‘n’.

The direct neighbor nodes of the node belonging to the first nodes represent nodes that only belong to the second nodes and the direct neighbor nodes of the node belonging to the second nodes represent nodes that only belong to the first nodes. For example, the direct neighbor nodes of the node belonging to the first nodes (e.g., the plurality of cardholders) can only be the nodes belonging to the second nodes (e.g., the plurality of merchants). Similarly, the direct neighbor nodes of the node belonging to the second nodes (e.g., the plurality of merchants) can only be the nodes belonging to the first nodes (e.g., the plurality of cardholders).

Alternatively, the skip neighbor nodes of the node belonging to the first nodes represent nodes that only belong to the first nodes and the skip neighbor nodes of the node belonging to the second nodes represent nodes that only belong to the second nodes. For example, the skip neighbor nodes of the node belonging to the first nodes (e.g., the plurality of cardholders) can only be the nodes belonging to the first nodes (i.e., the plurality of cardholders). Similarly, the skip neighbor nodes of the node belonging to the second nodes (e.g., the plurality of merchants) can only be the nodes belonging to the second nodes (i.e., the plurality of merchants).

The server system is configured to perform direct neighborhood aggregation methods and skip neighborhood aggregation methods to obtain direct neighborhood embeddings and skip neighborhood embeddings associated with the node respectively. The server system is further configured to combine the direct neighborhood embeddings and the skip neighborhood embeddings based, at least in part, on an attention mechanism. In one embodiment, the attention mechanism facilitates determining the importance of the direct neighborhood embeddings and the skip neighborhood embeddings by assigning a different amount of weightage or weights or values to the direct neighborhood embeddings and the skip neighborhood embeddings. The direct neighborhood embeddings and the skip neighborhood embeddings are combined/concatenated/fused to learn a comprehensive node embedding for the corresponding node.

The server system is configured to optimize the combination of the direct neighborhood embeddings and the skip neighborhood embeddings (i.e., the comprehensive node embedding) for obtaining a node embedding associated with the node based, at least in part, on a decoder model. The node embedding associated with the node also includes hidden information or hidden representation along with information extracted from self-features (i.e., plurality of node feature vectors) of the node.

In one embodiment, the server system is configured to calculate a loss value for maximizing information (i.e., the hidden information or the hidden representation) associated with the node embedding associated with the node. The loss value is calculated based on a weighted sum of a first loss value and a second loss value.

The server system is further configured to execute at least one of a plurality of graph context prediction tasks based, at least in part, on the final node representations of the first nodes and the second nodes. In one embodiment, the one or more applications and/or tasks include at least one of: (1) predicting fraudulent or non-fraudulent payment transactions, (2) calculating an account intelligence score, and (3) calculating a carbon footprint score.

Various embodiments of the present disclosure offer multiple technical advantages and technical effects. For instance, the present disclosure provides a scalable and time-efficient unsupervised graph representation learning methods. Further, the present disclosure provides more accurate predictions and reduces the time for determining node representations in bipartite graphs. Furthermore, the present disclosure provides significantly more robust solutions because of handling simultaneous/concurrent processor execution (such as applying one or more neural network models over the same input, simultaneously). Even further, the present disclosure improves the operations of processors because, by performing these synergistic operations to determine node representations of a bipartite graph that can be used for further downstream applications, the processors will require fewer computation cycles in learning node representations of the bipartite graphs.

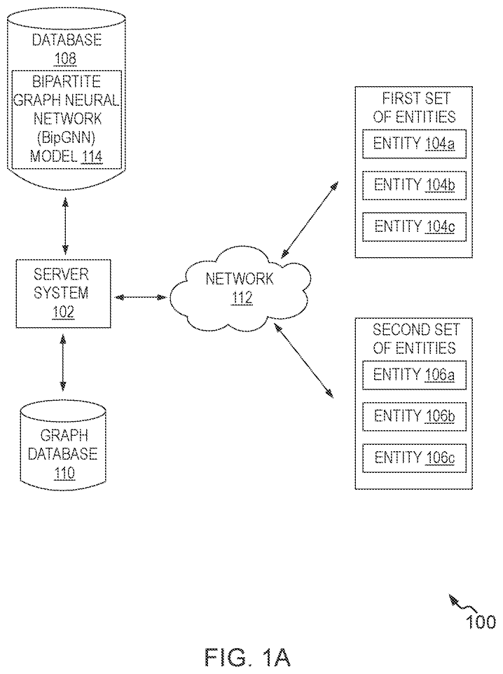

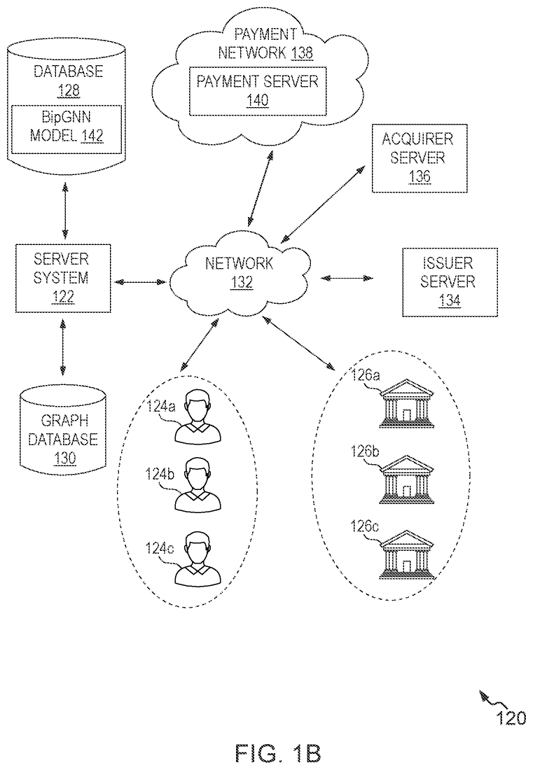

Various example embodiments of the present disclosure are described hereinafter with reference to FIGS. 1A to 9.

FIG. 1A illustrates an exemplary representation of an environment 100 related to at least some embodiments of the present disclosure. Although the environment 100 is presented in one arrangement, other embodiments may include the parts of the environment 100 (or other parts) arranged otherwise depending on, for example, unsupervised representation learning for bipartite graphs, etc. The environment 100 generally includes a server system 102, a first set of entities 104a, 104b and 104c, a second set of entities 106a, 106b and 106c, a database 108, and a graph database 110, each coupled to, and in communication with (and/or with access to) a network 112. The network 112 may include, without limitation, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, a virtual network, and/or another suitable public and/or private network capable of supporting communication among the entities illustrated in FIG. 1A, or any combination thereof.

Various entities in the environment 100 may connect to the network 112 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, future communication protocols, or any combination thereof. For example, the network 112 may include multiple different networks, such as a private network made accessible by the network 112 to the server system 102, and a public network (e.g., the Internet, etc.).

Examples of the first set of entities 104a-104c and the second set of entities 106a-106c, but are not limited to, medical facilities (e.g., hospitals, laboratories, etc.), financial institutions, educational institutions, government agencies, and telecom industries. In addition, each entity in the first set of entities 104a-104c may interact with entities of the second set of entities 106a-106c. The first set of entities 104a-104c may be associated (in some way or the other) or interact with the second set of entities 106a-106c.

The server system 102 is configured to perform one or more of the operations described herein. The server system 102 is configured to perform representation learning for bipartite graphs. The server system 102 is a separate part of the environment 100 and may operate apart from (but still in communication with, for example, via the network 112), the first set of entities 104a-104c, the second set of entities 106a-106c, and any third-party external servers (to access data to perform the various operations described herein). However, in other embodiments, the server system 102 may actually be incorporated, in whole or in part, into one or more parts of the environment 100, for example, the first entity 104a. In addition, the server system 102 should be understood to be embodied in at least one computing device in communication with the network 112, which may be specifically configured, via executable instructions, to perform as described herein, and/or embodied in at least one non-transitory computer-readable media.

The server system 102 is configured to access historical interaction data associated with the first set of entities 104a-104c and the second set of entities 106a-106c. The database 108 may store the interaction data including a plurality of interactions between the first set of entities 104a-104c and the second set of entities 106a-106c.

The term “interaction data” may include a reciprocal action. An interaction can include communication, contact, or exchange between parties, devices, and/or entities. Example interactions include a transaction between two parties and data exchange between two devices. In some embodiments, an interaction can include a user requesting access to secure data, a secure webpage, a secure location, and the like. In other embodiments, an interaction can include a payment transaction in which two devices can interact to facilitate payment.

The server system 102 is configured to generate a bipartite graph based, at least in part, on the historical interaction data. In one embodiment, the server system 102 is configured to receive the bipartite graph from the graph database 110. The graph database 110 is configured to store graph data (e.g., topological graphs). In some embodiments, the graph database 110 may store a plurality of graph instances of a dynamic bipartite graph. In some embodiments, the database 108 and the graph database 110 may be conventional, fault-tolerant, relational, scalable, secure databases such as those commercially available from third-party providers, etc. The bipartite graph represents a computer-based graph representation of the first set of entities 104a-104c as first nodes and the second set of entities 106a-106c as second nodes and interactions between the first nodes and the second nodes as edges. In one embodiment, the graph database 110 stores data associated with the bipartite graph.

In an example, the first set of entities 104a-104c represents a set of users, and the second set of entities 106a-106c represents a set of products listed on an e-commerce website or platform. The set of users includes users who have purchased at least one of the set of products listed on the e-commerce website. In addition, information associated with the set of users and the set of products is stored in the database 108. The set of users may be represented as the first nodes and the set of products may be represented as the second nodes. The edges may further exist between the first set of entities 104a-104c and the second set of entities 106a-106c for the set of users that may have purchased the set of products.

In another example, the first set of entities 104a-104c represent a set of authors, and the second set of entities 106a-106c represents a set of books. The set of authors may represent authors that have written or are creators of at least one of the set of books. In addition, information associated with the set of authors and the set of books is stored in the database 108. The set of authors may be represented as the first nodes and the set of books may be represented as the second nodes. The edges may further exist between the first set of entities 104a-104c and the second set of entities 106a-106c for the set of authors that may have written or are creators of the set of books.

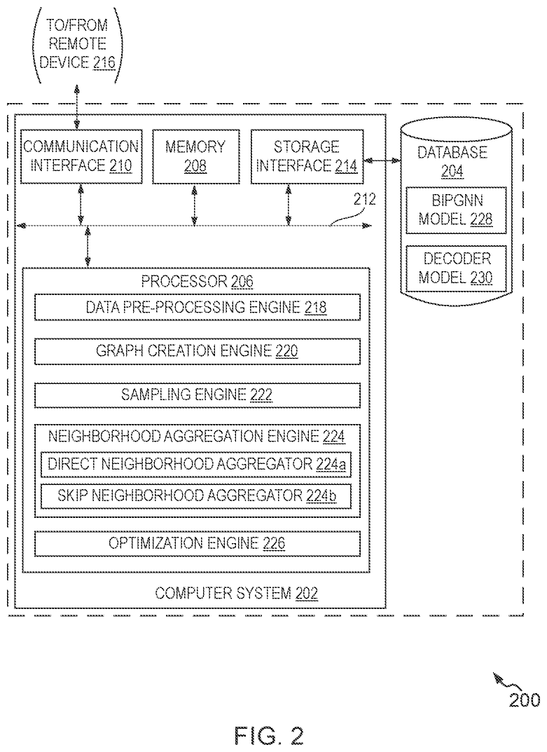

The server system 102 is configured to determine final node representations of the first nodes and the second nodes based, at least in part, on a bipartite graph neural network (BipGNN) model 114 stored in the database 108. The server system 102 is configured to perform a plurality of operations such as sampling, aggregation, optimization, etc. to determine the first node representations and the second node representations. A detailed explanation for performing the plurality of operations is herein explained in detail with reference to FIG. 2, and therefore, it is not reiterated for the sake of brevity.

FIG. 1B illustrates another exemplary representation of an environment 120 related to at least some embodiments of the present disclosure. Although the environment 120 is presented in one arrangement, other embodiments may include the parts of the environment 120 (or other parts) arranged otherwise depending on, for example, unsupervised representation learning for bipartite graphs, etc. The environment 120 generally includes a server system 122, a plurality of cardholders 124a, 124b and 124c, a plurality of merchants 126a, 126b and 126c, a database 128, a graph database 130, an issuer server 134, an acquirer server 136, and a payment network 138 including a payment server 140, each coupled to, and in communication with (and/or with access to) a network 132. The network 132 may include, without limitation, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, a virtual network, and/or another suitable public and/or private network capable of supporting communication among the entities illustrated in FIG. 1B, or any combination thereof.

Various entities in the environment 120 may connect to the network 132 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, or any combination thereof. For example, the network 132 may include multiple different networks, such as a private network made accessible by the network 132 to the server system 122, and a public network (e.g., the Internet, etc.).

In one embodiment, the plurality of cardholders 124a-124c may include a list of cardholders that may have performed a payment transaction through a payment instrument (e.g., payment card, payment wallet, payment account, etc.) at the plurality of merchants 126a-126c. In one embodiment, the payment account of the plurality of cardholders 124a-124c may be associated with an issuing bank (e.g., the issuer server 134). In one example, the plurality of cardholders 124a-124c may have utilized the payment instruments to perform the payment transactions at the plurality of merchants 126a-126c (e.g., payment terminals associated with the merchants 126a-126c, a merchant website, etc.).

In one embodiment, the plurality of cardholders 124a-124c may have performed the payment transaction online (i.e., by accessing merchant's website on a web browser or application installed in a computer system) or offline (i.e., by performing the payment transaction on a payment terminal (e.g., point-of-sale (POS) device, automated teller machine (ATM), etc.) installed in a facility). In a successful payment transaction, the payment amount may get debited from the payment account of the plurality of cardholders 124a-124c and get credited in the payment account of the plurality of merchants 126a-126c. In one embodiment, the payment account of the merchants 126a-126c may be associated with an acquirer bank (e.g., the acquirer server 136).

In one embodiment, the issuer server 134 is associated with a financial institution normally called an “issuer bank” or “issuing bank” or simply “issuer”, in which a cardholder may have a payment account, (which also issues a payment card, such as a credit card or a debit card), and provides microfinance banking services (e.g., payment transaction using credit/debit cards) for processing electronic payment transactions, to the cardholder.

In one embodiment, the acquirer server 136 is associated with a financial institution (e.g., a bank) that processes financial transactions. This can be an institution that facilitates the processing of payment transactions for physical stores, merchants, or an institution that owns platforms that make online purchases or purchases made via software applications possible (e.g., shopping cart platform providers and in-app payment processing providers). The terms “acquirer”, “acquiring bank”, “acquiring bank” or “acquirer server” will be used interchangeably herein.

The server system 122 is configured to perform one or more of the operations described herein. The server system 122 is configured to perform representation learning for bipartite graphs. In an embodiment, the server system 122 is identical to the server system 102 of FIG. 1A. In another embodiment, the server system 122 is the payment server 140. The server system 122 is a separate part of the environment 120 and may operate apart from (but still in communication with, for example, via the network 132), any third-party external servers (to access data to perform the various operations described herein). However, in other embodiments, the server system 122 may actually be incorporated, in whole or in part, into one or more parts of the environment 120, for example, the cardholder 124a. In addition, the server system 122 should be understood to be embodied in at least one computing device in communication with the network 132, which may be specifically configured, via executable instructions, to perform as described herein, and/or embodied in at least one non-transitory computer-readable media.

The server system 122 is configured to access historical transaction data associated with the plurality of cardholders 124a-124c and the plurality of merchants 126a-126c from the database 128. The database 128 may include the historical transaction data including a plurality of payment transactions performed between the plurality of cardholders 124a-124c and the plurality of merchants 126a-126c. In one embodiment, the payment transactions may be performed between the plurality of cardholders 124a-124c and the plurality of merchants 126a-126c over a time period (e.g., 1 year, 2 years, 7 years, etc.). The server system 122 is configured to generate a bipartite graph based, at least in part, on the historical transaction data. The bipartite graph represents a computer-based graph representation of the plurality of cardholders 124a-124c as first nodes and the plurality of merchants 126a-126c as second nodes and payment transactions performed between the first nodes and the second nodes as edges. In one embodiment, the graph database 130 stores graph data associated with the bipartite graph.

The server system 122 is configured to determine first node representations of the first nodes and second node representations of the second nodes based, at least in part, on a bipartite graph neural network (BipGNN) model 142 stored in the database 128. To determine the first node representations and the second node representations, the server system 122 is configured to perform a plurality of operations corresponding to each node of the first set of nodes and the second set of nodes.

At first, the server system 122 is configured to sample direct neighbor nodes and skip neighbor nodes associated with each node of the first set of nodes and the second set of nodes. This sampling of the direct neighbor nodes and the skip neighbor nodes is performed based on a neighborhood sampling method. Secondly, the server system 122 is configured to obtain direct neighborhood embeddings and skip-neighborhood embeddings of each node of the first nodes and the second nodes. The direct neighborhood embeddings are obtained based on direct neighborhood aggregation blocks and the skip neighborhood embeddings are obtained based on skip neighborhood aggregation blocks (explained in detail hereinafter with reference to FIG. 2).

The direct neighborhood embeddings and the skip neighborhood embeddings are combined to obtain a comprehensive node embedding for each node of the first nodes and the second nodes. The server system 122 is further configured to optimize the comprehensive node embedding based, at least in part, on a neural network model (i.e., decoder model) for obtaining a final node representation of the node. In this manner, the server system 122 is configured to determine the final node representations of the first nodes and the second nodes of the bipartite graph. The final node representations may further be used to perform one or more downstream applications, such as identifying fraudulent or non-fraudulent payment transactions, calculating an account intelligence score, calculating a carbon footprint score, and the like.

In one embodiment, the payment network 138 may be used by the payment card issuing authorities as a payment interchange network. The payment network 138 may include a plurality of payment servers such as the payment server 140. Examples of payment interchange networks include, but are not limited to, Mastercard® payment system interchange network. The Mastercard® payment system interchange network is a proprietary communications standard promulgated by Mastercard International Incorporated® for the exchange of financial transactions among a plurality of financial activities that are members of Mastercard International Incorporated®. (Mastercard is a registered trademark of Mastercard International Incorporated located in Purchase, N.Y.).

The number and arrangement of systems, devices, and/or networks shown in FIG. 1B is provided as an example. There may be additional systems, devices, and/or networks; fewer systems, devices, and/or networks; different systems, devices, and/or networks; and/or differently arranged systems, devices, and/or networks than those shown in FIG. 1B. Furthermore, two or more systems or devices shown in FIG. 1B may be implemented within a single system or device, or a single system or device shown in FIG. 1B may be implemented as multiple, distributed systems or devices. Additionally, or alternatively, a set of systems (e.g., one or more systems) or a set of devices (e.g., one or more devices) of the environment 120 may perform one or more functions described as being performed by another set of systems or another set of devices of the environment 120.

Referring now to FIG. 2, a simplified block diagram of a server system 200 is shown, in accordance with an embodiment of the present disclosure. The server system 200 is similar to the server system 102 or the server system 122. In some embodiments, the server system 200 is embodied as a cloud-based and/or SaaS-based (software as a service) architecture. The server system 200 includes a computer system 202 and a database 204. The computer system 202 includes at least one processor 206 for executing instructions, a memory 208, a communication interface 210, and a storage interface 214 that communicate with each other via a bus 212.

In some embodiments, the database 204 is integrated within the computer system 202. For example, the computer system 202 may include one or more hard disk drives as the database 204. The storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In one embodiment, the database 204 is configured to store a bipartite graph neural network (BipGNN) model 228 and a neural network model (i.e., decoder model 230).

Examples of the processor 206 include, but are not limited to, an application-specific integrated circuit (ASIC) processor, a reduced instruction set computing (RISC) processor, a complex instruction set computing (CISC) processor, graphical processing unit (GPU), a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In another embodiment, the memory 208 may be realized in the form of a database server or cloud storage working in conjunction with the server system 200, without departing from the scope of the present disclosure.

The processor 206 is operatively coupled to the communication interface 210 such that the processor 206 is capable of communicating with a remote device 216 such as, the payment server 140, or communicating with any entity connected to the network 112 (as shown in FIG. 1A) or the network 132 (as shown in FIG. 1B). In one embodiment, the processor 206 is configured to access historical transaction data including a plurality of payment transactions performed between the plurality of cardholders 124a-124c and the plurality of merchants 126a-126c from the database 128.

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one embodiment, the processor 206 includes a data pre-processing engine 218, a graph creation engine 220, a sampling engine 222, a neighborhood aggregation engine 224, and an optimization engine 226. It should be noted that components, described herein, such as the data pre-processing engine 218, the graph creation engine 220, the sampling engine 222, the neighborhood aggregation engine 224, and the optimization engine 226 can be configured in a variety of ways, including electronic circuitries, digital arithmetic and logic blocks, and memory systems in combination with software, firmware, and embedded technologies.

The data pre-processing engine 218 includes suitable logic and/or interfaces for accessing historical interaction data including a plurality of interactions associated with the first set of entities 104a-104c and the second set of entities 106a-106c from a database (e.g., the database 108) for a time period (e.g., 1 month, 6 months, 1 year, 2 years, etc.). The interaction data includes interactions between the first set of entities 104a-104c and the second set of entities 106a-106c.

With reference to the FIG. 1B, the data pre-processing engine 218 is configured to extract historical transaction data from a transaction database. The historical transaction data, but is not limited to, includes payment transactions performed between the plurality of cardholders 124a-124c and the plurality of merchants 126a-126c within a particular time interval. In one example, the historical transaction data includes information such as merchant name identifier, unique merchant identifier, a timestamp, geo-location data, information of the payment instrument involved in the payment transaction, and the like. The historical transaction data defines relationships between cardholder accounts and merchants. For example, when a cardholder purchases an item from a merchant, a relationship is defined. Thus, the historical transaction data can be leveraged to expose a variety of different attributes of the accounts, such as account activity, customer preferences, similarity to other accounts, and the like. However, the historical transaction data is sparse, as any given cardholder account (which includes merchant accounts that perform transactions with other merchants) interacts with a small fraction of merchants. Similarly, any given merchant may interact with a fraction of the cardholder accounts. Therefore, the historical transaction data implicitly creates a bipartite graph between accounts.

In one embodiment, the data-preprocessing engine 218 is configured to perform operations (such as data-cleaning, normalization, feature extraction, and the like) on the historical transaction data. In one embodiment, the data pre-processing engine 218 may use natural language processing (NLP) algorithms to extract a plurality of graph features based on the historical interaction data or the historical transaction data. In one embodiment, the plurality of graph features is converted into a vector format to be fed as an input to the BipGNN model 228. The plurality of graph features is used to generate the bipartite graph. In one embodiment, the plurality of graph features may include, but is not limited to, geo-location data associated with the payment transactions, population density, transaction velocity (i.e., frequency of financial transaction among the cardholders 124a-124c), historical fraud data, and transaction history. In one embodiment, the plurality of graph features is converted into a plurality of feature vectors.

The graph creation engine 220 includes suitable logic and/or interfaces for generating the bipartite graph based, at least in part, on the plurality of graph features (i.e., the plurality of feature vectors) identified from the historical interaction data or the historical transaction data. The bipartite graph represents a computer-based graph representation of the first set of entities 104a-104c as first nodes and the second set of entities 106a-106c as second nodes. In addition, interactions/relationships between the first nodes and the second nodes are represented as edges (i.e., weighted, or unweight).

In one embodiment, the plurality of feature vectors for a particular node may be represented as the plurality of node feature vectors. In addition, the plurality of node feature vectors for the first nodes is different from the plurality of node feature vectors for the second nodes. This difference arises due to the reason that the data features for the first nodes are always different from the data features for the second nodes in the bipartite graph. In one example, the plurality of data features associated with the cardholders 124a-124c may include demographic details such as name, age, gender, occupation details, employment details, average card spend, etc. The plurality of data features associated with the merchants 126a-126c includes merchant configuration profile, merchant identifier, chargeback data, etc.

The graph creation engine 220 may generate the bipartite graph associating the first nodes (e.g., the plurality of cardholders 124a-124c) and the second nodes (e.g., the plurality of merchants 126a-126c) using one or more relationships (i.e., edges). In this case, the bipartite graph may include the first nodes (e.g., nodes relating to the payment instruments associated with the plurality of cardholders 124a-124c, etc.), the second nodes (e.g., nodes relating to merchant identifiers associated with the plurality of merchants 126a-126c) and edges (e.g., edges representing payment transactions among the related nodes). The bipartite graph is a node-based structure including a plurality of nodes (e.g., the first nodes and the second nodes). In one example, the first nodes are connected to the second nodes using respective edges. In one embodiment, the first nodes are disjoint and independent from the second nodes. In some embodiments, the bipartite graph may include metadata associated with the nodes (i.e., the first nodes and the second nodes), and/or information identifying the one or more relationships (for example, payment transactions, etc.) among the nodes. In addition, the bipartite graph gets modified with time. In one example, each edge of the bipartite graph represents a payment transaction performed between a cardholder (e.g., the cardholder 124a) and a merchant (e.g., the merchant 126a).

In one embodiment, the processor 206 is configured to execute a plurality of operations to determine a node representation of each node in the bipartite graph based, at least in part, on the BipGNN model 228. In one embodiment, the BipGNN model 228 may execute or run machine learning algorithms based on graph neural networks (GNNs). The BipGNN model 228 includes a plurality of graph neural networks and a decoder model. The BipGNN model 228 is trained based on the historical interaction data between the first set of entities and the second set of entities.

The sampling engine 222 includes suitable logic and/or interfaces for sampling sets of neighbor nodes associated with a root node based, at least in part, on a neighborhood sampling method. The neighborhood sampling method overcomes multiple drawbacks to existing GNN based representation learning. The multiple drawbacks are as (a) high variance in node degree in real-life bipartite graphs and the influence of high-degree nodes and (b) same weight for both strong and weak connections. The neighborhood sampling method defines a probability function for calculating the probability of sampling a node ‘n’ for a root node ‘m’. The probability function is proportional to the strength of the weighted edge or connection between the node ‘n’ and the root node ‘m’. In general, the degree of a node is the number of connections that a node has to other nodes in a network graph. Based on the probability function defined in the neighborhood sampling method, the sampling engine 222 is configured to penalize the nodes that have a high degree, thereby reducing their influence, and giving more weightage to strong connections, thereby avoiding learning from weakly connected neighbors.

In particular, the sets of neighbor nodes include direct neighbor nodes and skip neighbor nodes of the root node. In one example, when the root node is a cardholder, direct neighbor nodes of the root nodes would be merchants, and skip neighbor nodes would be cardholders connected with the merchants. Therefore, the direct neighbor nodes of any node can only be the nodes that belong to a different domain.

Since, in bipartite graphs, the direct neighbor nodes of any node will always be of a different kind of node, aggregating from only direct neighbor nodes will not be sufficient to learn the final node representation of the node. Therefore, the processor 206 is configured to capture information (i.e., node feature vectors) of direct neighbor nodes and skip neighbor nodes of the root node to determine node representation of the root node.

The neighborhood aggregation engine 224 includes suitable logic and/or interfaces for executing direct neighborhood aggregation methods and skip neighborhood aggregation methods to obtain direct neighborhood embeddings and skip neighborhood embeddings associated with the root node, respectively. The neighborhood aggregation engine 224 includes two aggregators: (a) direct neighborhood aggregator 224a, and (b) skip neighborhood aggregator 224b. In one embodiment, each aggregator implements a feed-forward neural network (FNN).

In general, FFN is a class of artificial neural networks in which connections between units do not form a cycle or a loop. More specifically, information only travels forward in the network (i.e., no loops or back-propagation), first through input nodes, then through the hidden nodes (if present), and finally through the output nodes. The FFN is fed with the plurality of node feature vectors as an input, followed by an aggregator function, such as graph convolutional networks (GCN) aggregator, mean aggregator, long short-term memory (LSTM) aggregator, and the like. In general, GCN is a neural network architecture used to perform machine learning operations on a graph. In general, LSTM is a class of artificial recurrent neural network architecture used to perform tasks such as, classifying, processing, and making predictions based on time series data, since there can be lags of unknown time duration between important events in a time series.

In one embodiment, the direct and skip neighborhood aggregators implement a mean aggregator. The mean aggregator is configured to take an element-wise mean of output vectors of FFNs. In one example, the symmetrical property of the mean aggregation function ensures that the neural network model (i.e., FFNs) can be trained and applied to arbitrarily ordered node neighborhood features.

In one embodiment, the direct neighborhood aggregator 224a and the skip neighborhood aggregator 224b are configured to learn how to aggregate neighbor node features during the training process. The direct neighborhood aggregator 224a is configured to aggregate node feature vectors for every neighboring node of the root node. The skip neighborhood aggregator 224b is configured to aggregate skip neighbor nodes of the root node.

In one example, for a root node or an individual node A, there are two sampled direct neighbor nodes B1 and B2. The direct neighbor node B1 is connected with nodes C1 and C2 and the direct neighbor node B2 is connected with nodes C3 and C4. In the direct neighborhood aggregation method for root node A, node features vectors of the nodes C1 and C2 are aggregated for the direct neighbor node B1 to generate the first hidden node representation i.e., CB1 and node feature vectors of the nodes C3 and C4 are aggregated for the direct neighbor node B2 to generate second hidden node representation i.e., CB2 Thereafter, the first and second hidden node representations are aggregated to compute a direct neighborhood embedding (i.e., latent space representation). In the skip neighborhood aggregation method, nodes feature vectors of the nodes C1, C2, C3, and C4 are directly aggregated to obtain a skip neighborhood embedding.

Thereafter, the neighborhood aggregation engine 224 is configured to combine the direct and skip neighborhood embeddings to learn a comprehensive node embedding for the root node. In other words, the neighborhood aggregation engine 224 is configured to fuse direct and skip neighborhood embeddings based, at least in part, on an attention mechanism.

The attention mechanism facilitates the determination that how much weight or attention should be provided to the direct neighborhood embeddings and the skip neighborhood embeddings. In one embodiment, the sum of the direct neighborhood embeddings and the skip neighborhood embeddings is always 1. In this manner, the attention mechanism helps to determine or learn the importance of two different types of embeddings (i.e., the direct neighborhood embeddings and the skip neighborhood embeddings) coming from two different types of neighbors (i.e., the direct neighbor nodes and the skip neighbor nodes).

The optimization engine 226 is configured to optimize the comprehensive node embedding (i.e., a combination of the direct neighborhood embeddings and the skip neighborhood embeddings) to obtain a final node representation associated with the root node based, at least in part, on a neural network model (i.e., a decoder model 230). The decoder model 230 is configured with an objective to maximize the mutual information between the comprehensive node embedding and the self-node features of the root node. In general, the decoder model 230 includes an architecture used to decode encoded input sequences into a target input sequence.

In one embodiment, the BipGNN model 228 is trained based, at least in part, on a dual loss function that is calculated based on a weighted sum of a first loss value and a second loss value. In one embodiment, the first loss value is a mean squared error (MSE) loss based on mean squared error for minimizing entropy between comprehensive node embedding and the self-node features of the node. In other words, the first loss value preserves mutual information between the comprehensive node embedding and the self-node features of the node. The second loss value preserves the graph structure of the bipartite graph. In one embodiment, the dual loss value is calculated based on a reconstruction loss and a graph context loss. In one embodiment, the graph context loss is calculated based on the comprehensive embedding only and the reconstruction loss is calculated based on the comprehensive embedding and the plurality of node feature vectors (i.e., self-node features of the node). In one embodiment, the optimization engine 226 is configured to perform the optimization process to indirectly use the plurality of node feature vectors (i.e., self-node features of the node) to learn the hidden representations. The optimization process is also performed to make the hidden representations useful to perform the one or more downstream applications and/or tasks.

In one embodiment, the processor 206 is configured to execute at least one of a plurality of graph context prediction tasks based, at least in part, on the final node representations of the first nodes and the second nodes. The plurality of graph context prediction tasks may include, but not limited to, (a) predicting fraudulent or non-fraudulent payment transactions, (b) calculating an account intelligence score, and (c) calculating a carbon footprint score.

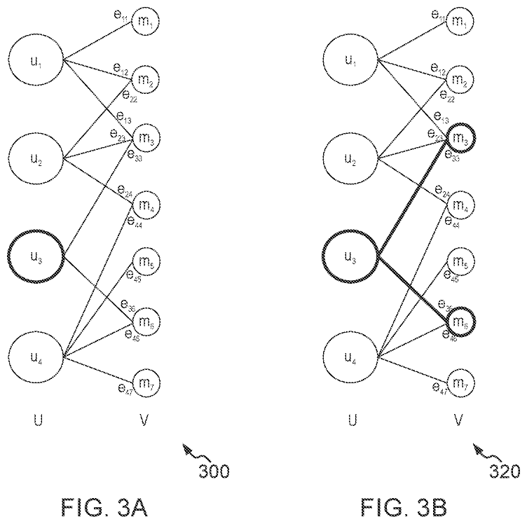

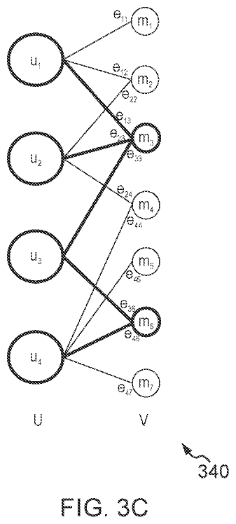

FIGS. 3A-3C depict example representations of a bipartite graph, in accordance with an embodiment of the present disclosure.

As explained above, the processor 206 is configured to generate the bipartite graph based on the plurality of graph features for the first nodes and the second nodes. In one embodiment, the plurality of graph features may include, but are not limited to, geo-location data associated with the payment transactions, population density, transaction velocity (i.e., frequency of payment transactions at the plurality of merchants 126a-126c), historical payment transaction data, and transaction history. The bipartite graph represents a computer-based graph representation of the first set of entities 104a-104c (e.g., the plurality of cardholders 124a-124c) as the first nodes and the second set of entities 106a-106c (e.g., the plurality of merchants 126a-126c) as the second nodes. In addition, relationships between the first nodes and the second nodes are represented as the edges (e.g., weighted, or unweight). The relationship between the first nodes and the second nodes is set forth in solid, dashed, and/or bolded lines (e.g., with arrows). The processor 206 is also configured to determine weights and directions of edges based on the plurality of node feature vectors (not shown in figures).

Referring now to FIG. 3A, an example representation 300 of a bipartite graph G is shown. The bipartite graph G is defined and generated based on the plurality of graph features (i.e., the plurality of node feature vectors) extracted from the historical interaction data or the historical transaction data. The bipartite graph G represents a computer-based graph representation of the plurality of cardholders 124a-124c as the first nodes U1-U4 and the plurality of merchants 126a-126c as the second nodes M1-M7. In one embodiment, the edges may represent payment transactions performed between the plurality of cardholders U1-U4 and the plurality of merchants M1-M7. In one embodiment, the processor 206 is configured to update the bipartite graph G by adding the first nodes or the second nodes, adding edges, removing the first nodes or the second nodes, removing edges, adding additional metadata for the existing first nodes, and the second nodes, removing metadata for the existing first nodes and the second nodes, and/or the like.

In one embodiment, the bipartite graph G is defined as G=(U, V, E), where U and V represent two different sets containing two different types of nodes. In one embodiment, U represents the first set of entities 104a-104c or the plurality of cardholders 124a-124c. In addition, V represents the second set of entities 106a-106c or the plurality of merchants 126a-126c. Further, uᵢ∈U and vⱼ∈V denote i-th and j-th nodes in U and V respectively. Furthermore, eᵢⱼ∈E denotes the edge between uᵢ and vⱼ. Here, i=1, 2, 3, . . . , M and j=1, 2, 3, . . . , N.

Moreover, each edge eᵢⱼ is represented by a weight wᵢⱼ. The weight wᵢⱼ defines the strength of the connection. Additionally, the features of two sets of nodes may be represented as X_{U} and X_{V} respectively, where Xᵤ∈R^{M*P} and X_{V} ∈R^{N*Q}. In one embodiment, the processor 206 is configured to execute an unsupervised node representation learning algorithm (e.g., BIPGNN model 228) for the bipartite graph G such that the final embedding of any node is a function solely of features of its neighboring nodes (e.g., the direct neighbor nodes and the skip neighbor nodes). This further ensures a low correlation in information between self-node features of each node and learned node representations.

Referring now to FIG. 3B, an example representation 320 of sampling of direct neighbor nodes of a root node (e.g., cardholder node ‘u3’) is shown. As shown in FIG. 3B, the node belonging to the first nodes (i.e., root node or cardholder node ‘u3’) of the bipartite graph G is connected to the direct neighboring nodes (i.e., the plurality of merchants ‘m3’ and ‘m6’). The edges e₃₃ and e₃₆ represent the connection between the root node ‘u3’ and its direct neighboring nodes (i.e., merchant nodes ‘m3’ and ‘m6’ respectively).

Referring now to FIG. 3C, an example representation 340 of sampling of skip neighbor nodes of the root node (e.g., cardholder node ‘u3’) is shown. The skip neighbor nodes of the node belonging to the first nodes can only be those nodes that belong to the first nodes. As shown in FIG. 3B, the direct neighbor nodes of the cardholder node ‘u3’ are the merchant nodes ‘m3’ and ‘m6’. Therefore, the skip neighbor nodes of the cardholder node ‘u3’ are those cardholder nodes (i.e., the first nodes) that further connect with the merchant nodes ‘m3’ and ‘m6’. As shown in FIG. 3C, the cardholder node ‘u1’, ‘u2’, and ‘u4’ represent the skip neighbor nodes of the cardholder node ‘u3’.

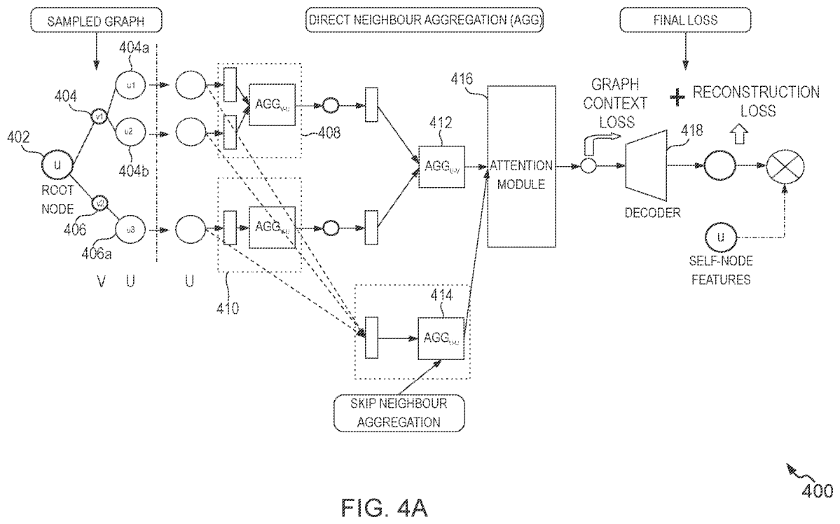

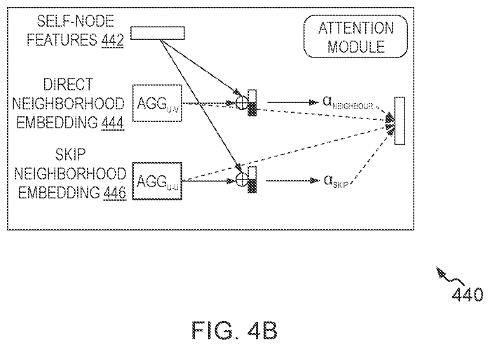

FIG. 4A is a block diagram representation 400 of BipGNN model, in accordance with an embodiment of the present disclosure. The block diagram representation 400 explains end to end training process of BipGNN model, starting from neighborhood sampling strategy, method of learning from direct and skip neighbor nodes, and a novel dual loss function to optimize the bipartite graph in an unsupervised approach. For illustration purposes, it is assumed that the BipGNN model learns node representation of node ‘u’, referred to as a root node 402. In similar manner, the processor 206 is configured to perform training process for all remaining nodes in a graph traversal manner.

At first, the processor 206 is configured to sample sets of neighbor nodes of the root node 402 based, at least in part, on a neighborhood sampling method. In the neighborhood sampling method, the processor 206 is configured to compute a probability function of sampling a node ‘n’ for the root node ‘m’ that is defined as below:

P(n/m)∝log(wₙₘ)/log(O(n)) Eqn. (1)

where wₙₘ provides an edge strength of a connection between the node ‘n’ and the root node ‘m’ and O(n) is the degree of the node ‘n’. In general, the degree of the node represents the number of connections that a node has to other nodes in a network. Because of the above-stated neighborhood sampling method, the processor 206 is configured to penalize the nodes that have a high degree, thereby reducing their influence and providing more weightage to strong connections, and avoiding learning from weakly connected neighboring nodes.

As shown in the FIG. 4A, the root node 402 is sampled with two direct neighbor nodes v1 (see, 404) and v2 (see, 406). The node v1 is connected with nodes u₁ (see, 404a), u₂ (see, 404b) and the node v2 is connected with the node u₃ (see, 406a). Since, in bipartite graphs, the direct neighbor nodes of any node will always be of a different kind of node, aggregating from only direct neighbor nodes will not be sufficient to learn the final node representation of the root node. Therefore, the processor 206 is configured to capture information (i.e., node feature vectors) of direct neighbor nodes and skip neighbor nodes of the root node to determine the final node representation of the root node 402. Thus, the direct neighbor nodes of any given node of the bipartite graph are always those nodes that belong to the different domain/partition/set (e.g., the other set of entities).

In one embodiment, the processor 206 is configured to sample two sets of neighbor nodes N(u) and N(N(u)), where N(u) represents the direct neighbor nodes of a root node ‘u’ and N(N(u)) represents skip neighborhood of the root node ‘u’. To capture information from the direct neighbor nodes as well as the skip neighbor nodes of the root node ‘u’, a direct neighborhood aggregation block and a skip neighborhood aggregation block is utilized.

To capture information from the direct neighbor nodes of the root node ‘u’, the processor 206 is configured to perform a two-step process. Initially, the processor 206 is configured to calculate aggregation vectors for every neighboring node of the root node ‘u’. Let us consider that vᵢ∈N(u) is the direct neighbor nodes of the root node ‘u’ and ũᵢⱼ∈N(vᵢ) is the direct neighbor nodes of vᵢ. For each vᵢ∈N(u), an aggregation block (see, 408, 410) is applied as:

h_{N(v}_{ᵢ}₎=AGGREGATEᵥᵤ(X_{ũ}_{ᵢⱼ},∀ũᵢⱼ∈N(vᵢ)) Eqn. (2)

where h_{N(v}_{ᵢ}₎∈ [symbol] ^{d*1} is an aggregation vector of a node vᵢ and X_{ũ}_{ᵢⱼ} ∈ [symbol] ^{P} is a feature vector of ũᵢⱼ∈N(vᵢ). Iteratively, these vectors h_{N(v}_{ᵢ₎} of each vᵢ are passed through another aggregation block 412 (i.e., AGGREGATEᵤᵥ) to calculate the final direct neighborhood embedding h_{N(u)} of the root node ‘u’ as:

h_{N(u)}=AGGREGATEᵤᵥ([h_{N(v}_{ᵢ}₎,Xᵥ_{ᵢ}],∀vᵢ∈N(u)) Eqn. (3)

To further capture information from the skip neighborhood of the root node ‘u’, the processor 206 is configured to directly aggregate the neighboring nodes of vᵢ and pass through an aggregator block 414 (i.e., AGGREGATEᵤᵤ). More specifically, the processor 206 is configured to calculate the skip neighborhood embedding of the root node ‘u’ as:

h_{(N(N(u))}=AGGREGATEᵤᵤ(X_{ũ}_{ᵢⱼ},∀ũᵢⱼ∈N(N(u)) Eqn. (4)

It should be noted that different aggregation blocks (e.g., AGGREGATEᵥᵤ, AGGREGATEᵤᵥ, AGGREGATEᵤᵤ, etc.) are used for different combinations of nodes. For example, AGGREGATEᵥᵤ is used specifically for aggregating nodes of type U when the root node is of type V. In this manner, the processor 206 is configured to handle the heterogeneity of the bipartite graph G. In one embodiment, each aggregator block consists of a Feed-forward network (FFN) that takes the plurality of node feature vectors as an input, followed by an aggregator function like GCN aggregator, mean aggregator, LSTM aggregator, and the like. In one embodiment, the mean aggregator is used to compute an element-wise mean of output vectors of FFNs. In one example, the symmetrical property of the mean aggregator ensures that the neural network model (e.g., FFN) may be trained and applied to arbitrarily ordered node neighborhood features.

The processor 206 is further configured to learn the comprehensive node embedding from the direct neighborhood embedding and the skip neighborhood embedding. To learn the comprehensive node embedding for the root node ‘u’, the processor 206 is configured to fuse/combine/concatenate the direct neighborhood embedding and the skip neighborhood embedding intelligently using an attention module 416.

Referring now to FIG. 4B, a block diagram representation 440 of an attention module (i.e., attention module 416) for combining the direct neighborhood embedding and the skip neighborhood embedding of a root node is shown, in accordance with an embodiment of the present disclosure. More specifically, the processor 206 is configured to utilize a self-attention mechanism (i.e., attention mechanism) to automatically learn the importance of embeddings (i.e., the direct neighborhood embedding 444 and the skip neighborhood embedding 446) emerging from two different types of neighbors (i.e., the direct neighbor nodes and the skip neighbor nodes) with respect to self-node features 442 of the root node. The attention mechanism may be defined as:

$${h}_{u} = {\sum }_{i ∈ [ N ( u ) , N ( N ( u ) )} {α}_{i} * {h}_{i} , \qquad Eqn . ( 5 )$$

$${α}_{i} = \frac{exp ( LReLU ( {z}^{T} [ {X}_{u} , {h}_{i} ] ) )}{{\sum }_{i ∈ [ N ( u ) , N ( N ( u ) )} exp ( LReLU ( {z}^{T} [ {X}_{u} , {h}_{i} ] ) )}$$

where hᵤ is the final embedding of root node ‘u’ and Xu∈ [symbol] ^{P} is the self-node features (e.g., the plurality of node feature vectors) of the root node ‘u’. αᵢ's are the importance of hᵢ. The “LReLU” denotes a leaky version of a Rectified Linear Unit. z∈ [symbol] ^{(d+P)*1} is an attention parameter. In general, the “LReLU” is a rectified-based activation function. It is noted that self-node features of the root node are used only to define attention weights and are not directly used in the final node representation, itself. This is important for learning enriched node representations as it limits the correlation of these embeddings with the self-node features. Thus, the attention mechanism defines attention weights of the direct neighborhood embedding and the skip neighborhood embedding based on corresponding correlation values of the direct and skip neighborhood embeddings with self-node features of the node.

In addition, it should be noted that a single layer BipGNN model 228 can be generalized up to K layers as described in the BIPGNN algorithm.

Referring now back to the FIG. 4A, the processor 206 is configured to optimize the comprehensive node embedding to learn the node embedding for the node (e.g., the root node ‘u’). In this manner, the processor 206 is configured to learn the first node representations (i.e., embeddings) for the first nodes and the second node representations (i.e., embeddings) for the second nodes. To learn the node representations that may further be used for the one or more downstream applications and/or tasks, the following observations can be interpreted: (a) the BipGNN model 228 needs to be trained in an unsupervised manner, hence making it impossible to directly optimize a task-specific loss (b) the node representations need to be explicitly learned only from the plurality of node features of the neighboring nodes, and also implicitly capture the information from the node's self-features. To overcome these limitations, the processor 206 is configured to utilize the known structure of the input to design objectives based on mutual information (MI).

Therefore, the processor 206 is configured to design a decoder 418 i.e., f_{θ}(h) to maximize the mutual information (I(h, X)) between neighborhood aggregated graph embeddings (h) and self-node features (X). The decoder 418 is configured to reconstruct the node features from the neighborhood graph embeddings, formally denoted as X=f_{θ}(h)+δ, where δ is the error of the decoder 418. The mean squared error (MSE) of the estimated error is as follows: [symbol] [|X−f_{θ}(h)|²]= [symbol] [δ]=|Σ|, assuming noise to be Gaussian with variance Σ and the self-features of the nodes as X∈ [symbol] ^{P}. Further, the MI between h and X may be rewritten as I(X, h)=H(X)−H(X|h). Here, the objective should minimize H(X|h) (see, Eqn. (6)):

$$H ( X \vert h ) = {\int }_{ℋ} p ( \tilde{h} ) H ( {f}_{θ} ( \tilde{h} ) + δ \vert h = \tilde{h} ) d \tilde{h} = {\int }_{ℋ} p ( \tilde{h} ) H ( δ \vert h = \tilde{h} ) d \tilde{h} = \frac{log {( 2 π e )}^{P} \vert Σ \vert}{2} \qquad Eqn . ( 6 )$$

Since, maximizing the mutual information I(h, X) is equivalent to minimizing MSE loss as

$$𝔼 [ {\vert X - {f}_{θ} ( h ) \vert}^{2} ] = \frac{1}{{( 2 π e )}^{P}} exp [ 2 H ( X \vert h ) ] .$$

Thus, the first component of the loss function (e.g., the first loss value) is:

o₁=∥f_{θ}(h)−X∥² Eqn. (7)

To compute the second component of the loss function (e.g., the second loss value), a variant of graph contextual loss is added to capture the local structure of the bipartite graph G. The processor 206 is configured to calculate the second loss value that enables learning representations for different node types (i.e., the first nodes and the second nodes) independently and simultaneously as:

o₂=−log σ(hᵤ_{₁}^{T}hᵤ_{₂})−Q*log(1−σ(hᵤ_{₁}^{T}hᵤ_{₃}) Eqn. (8)

where u₁ and u₂ are positive samples and u₁ and u₃ are negative samples occurring on a fixed-length random walk based on the neighborhood sampling method. In addition, u₁, u₂, and u₃ are nodes of the same type, σ is the sigmoid function, and Q defines the number of negative samples. In one embodiment, a separate loss value for the nodes v₁, and v₂. is calculated based on the above-stated loss function and added to o₂. Therefore, the final loss value is defined as: o_{final}=o₁+λo₂, where λ is a hyper-parameter. The final loss value handles dual tasks of (1) preserving the structure of the bipartite graph G, and (2) high mutual information with self-node features. In one embodiment, all the model parameters are learned via stochastic gradient descent with the Adam optimizer. In addition, the training iterations are repeated until convergence. The learned embeddings are concatenated with the node's self-node features and can cater to one or more different domain agnostic downstream applications and/or tasks.

In one embodiment, the BipGNN model 228 is configured to run the BipGNN algorithm extended up to K layers. The BipGNN algorithm is defined as:

for u ∈ U do
for iteration = 1, 2, ... K do
h_{N(u)}^{k} = AGGREGATEᵤᵥ ([h_{N(v}_{ᵢ}₎^{k}, hᵥ_{ᵢ}^{k-1}], ∀vᵢ ∈ N(u))
h_{N(N(u))}^{k} h = AGGREGATEᵤᵤ (h_{ũ}^{k-1}, ∀ũ ∈ N(N(u))
end for
hᵤ = α₁h_{N(u)}^{K} + α₂h_{N(N(u)}^{K}
end for

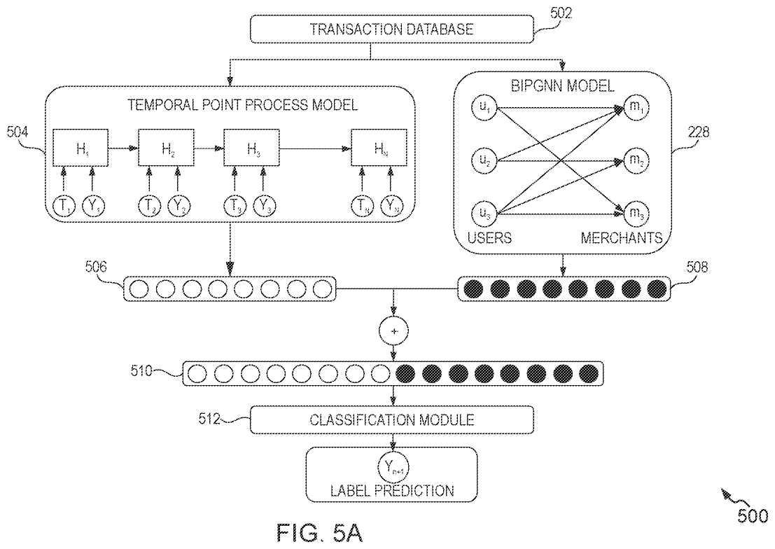

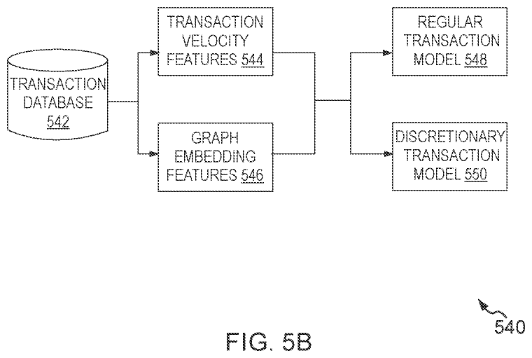

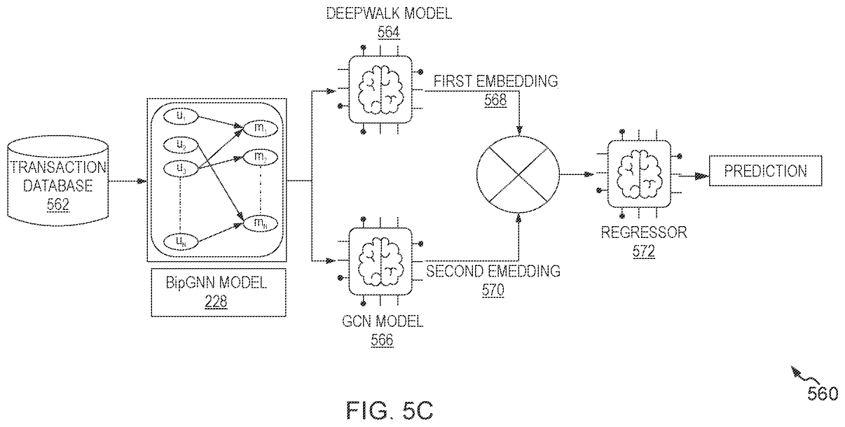

FIGS. 5A-5C show example representations of practical applications of BipGNN model to perform a plurality of graph context prediction tasks, in accordance with embodiments of the present disclosure. In one embodiment, the processor 206 is configured to retrieve graph data from the graph database and determine final node representations of the first nodes and second nodes of the bipartite graph using the BipGNN model. The final node representations are utilized for executing a plurality of graph context prediction tasks.

Referring now to the FIG. 5A, a block diagram representation 500 for identifying fraudulent or non-fraudulent payment transactions is shown, in accordance with an embodiment of the present disclosure. At first, the processor 206 is configured to access historical transaction data including a plurality of payment transactions (e.g., fraudulent, and non-fraudulent) between the plurality of cardholders 124a-124c and the plurality of merchants 126a-126c from a transaction database 502.

In one embodiment, the historical transaction data may undergo data pre-processing operations (e.g., data cleaning, normalization, etc.) and a featurization process for generating a plurality of feature vectors based on the historical transaction data. In one example, the plurality of feature vectors may be generated based on the spending behavior of the cardholders 124a-124c, payment behavior of the cardholders 124a-124c, and customer credit bureau information (for example, credit score), etc. In one embodiment, the historical transaction data includes past transaction sequence, numerous predictive variables and a binary flag indicating whether the payment transaction was fraudulent or not. In general, a fraudulent payment transaction may be reported by the cardholder 124a sometime after the payment transaction occurs, may be reported by the cardholder's bank, may be indicated by a chargeback, or may be discovered in other ways. The binary flag may be set for a payment transaction in the transaction database 502 at any suitable time. The predictive variables known in the art include such as “whether the dollar amount of the transaction is in a particular range”, “how many orders have been completed by a particular user device in the last thirty days”, and the like.

In one embodiment, a fraud feature vector is generated for the past transaction sequence based on the binary flag associated with each payment transaction included in the past transaction sequence. In one embodiment, the fraud feature vector is utilized for modeling the temporal point process (TPP) model 504. In an embodiment, data stored in the transaction database 502 is used to model the TPP model 504. In another embodiment, data stored in the transaction database 502 is used to model the BipGNN model 228 (as explained above in detail with reference to FIG. 2 and FIG. 4A).

The TPP model 504 takes past transaction sequence and past marker sequence (i.e., fraud feature vector) as inputs. In one embodiment, the TPP model 504 may predict the event marker for the next event based on analysis of the past transaction sequence and past marker sequence. In addition, the TPP model 504 may utilize the actual time (real-time) of the next event for predicting the corresponding marker. In one embodiment, the TPP model 504 demonstrates high applicability in scenarios where the marker (e.g., fraudulent, or non-fraudulent transaction) is computed or derived after some time as opposed to being simultaneously available with the event occurrence. As shown in FIG. 5A, there is a sequence of events denoted by their time of occurrence and corresponding markers. Mathematically, each sequence is represented by S={(t₁, y₁), (t₂, y₂), . . . , (tₙ, yₙ)}, where n refers to the total sequence length. Here, (tⱼ, yⱼ) refers to the j^{th} event represented by the time of the event (tⱼ) and the corresponding marker (yⱼ). By default, the events are ordered in time, such that tⱼ₊₁≥tⱼ. Given the sequence of last n events, the task should predict the next event time tₙ₊₁ and the corresponding marker yₙ₊₁. The term event here refers to a transaction, event time refers to the time of the transaction, and the term event marker refers to whether the transaction (event) was fraudulent or not.

In one embodiment, the TPP model 504 utilizes a recurrent neural network (RNN) as backbone architecture to learn the first embedding (i.e., the temporal embedding 506) based on analysis of past events. In general, RNN is a feed-forward neural network structure. In RNN, additional edges (also known as recurrent edges) are added such that the outputs from the hidden units at the current time step are fed into them again as future inputs at the next time step. In consequence, the same feed-forward neural network structure is replicated at each time step, and the recurrent edges connect the hidden units of the network replicated at adjacent time steps across time. In RNN, the hidden units with recurrent edges not only receive the input from the current data sample but also from the hidden units in the last time step. This feedback mechanism creates an internal state of the network to memorize the influence of each past data sample. The TPP model 504 fetches the real-time sequence of the transaction and generates the temporal embedding 506.

In one embodiment, the processor 206 is configured to generate a bipartite transaction graph based on the historical transaction data between a plurality of merchants and a plurality of cardholders. Thereafter, BipGNN model 228 is configured to determine structural embedding 508 of the bipartite transaction graph. A detailed explanation for performing the steps for obtaining the structural embedding 508 (i.e., final node representations) for the first nodes (e.g., cardholders) and the second nodes (e.g., merchants) of the bipartite transaction graph is herein explained in detail with reference to FIG. 2, and therefore, they are not reiterated for the sake of brevity. The temporal embedding 506 is concatenated/fused with the structural embedding 508 obtained from the BipGNN model 228 (see, 510). Moreover, the concatenated embedding 510 (i.e., a combination of the temporal embedding 506 and the structural embedding 508) is fed as an input to a classification module 512. The classification module 512 performs the classification to predict the next marker (yₙ₊₁) of the payment transaction. More specifically, the classification module 512 predicts whether the next payment transaction is a fraudulent transaction or a non-fraudulent payment transaction.

Thus, the BipGNN model helps in determining structural information of bipartite transaction graph for predicting fraudulent transactions.

Referring now to FIG. 5B, a schematic block diagram 540 of a process for calculating an account intelligence score is shown. In one embodiment, the processor 206 is configured to access historical transaction data from a transaction database 542. The historical transaction data may include historical data of payment transactions performed between cardholders (e.g., the plurality of cardholders 124a-124c) and merchants (e.g., the plurality of merchants 126a-126c) over the time period (e.g., 1 month, 6 months, 1 year, 2 years, etc.). In one embodiment, the historical transaction data may undergo data pre-processing operations (e.g., data cleaning, normalization, etc.) and a featurization process. In one embodiment, the processor 206 is configured to generate a bipartite graph based on the historical transaction data and determine graph embeddings (i.e., final node representations) of the cardholders and the merchants. In one embodiment, the processor 206 is also configured to generate transaction velocity features 544. The transaction velocity features 544 may include but are not limited to, total purchase amount for a pre-determined duration spent at each merchant, total purchase amount spent by the plurality of cardholders 124a-124c possessing different payment card types for the pre-determined duration, the total number of transactions performed by the plurality of cardholders 124a-124c having different payment card types within the pre-determined duration, the total number of online payment transactions performed at each merchant within the pre-determined duration, and total numbers of payment transactions involving a payment card at each merchant within the pre-determined time duration

In one example, graph embedding features 546 may include, but is not limited to, geo-location data associated with the payment transactions, population density, transaction velocity (i.e., frequency of payment transactions performed by a cardholder to a particular cardholder), and transaction history.

The graph embedding features 546 and the transaction velocity features 544 may be fed as inputs to a regular transaction model 548 and a discretionary transaction model 550. In one embodiment, the regular transaction model 548 and the discretionary transaction model 550 are based on the BipGNN model 228. The regular transaction model 548 is configured to calculate the account intelligence score of everyday spending for each cardholder of the plurality of cardholders 124a-124c. In general, everyday spend is defined as total spend (i.e., transaction or purchase, etc.) performed by the cardholder in everyday industries (for example, groceries, fuel, utilities, etc.).

The discretionary transaction model 550 is configured to calculate the account intelligence score of discretionary spend for each cardholder of the plurality of cardholders 124a-124c. In general, discretionary spend is defined as total spend (i.e., transaction or purchase, etc.) performed by the cardholder in discretionary industries (for example, travel, lodging, restaurants, etc.). In one example, 231 transaction velocity features and 128 graph embedding features are used to train both the regular transaction model and the transaction discretionary model. However, the number of features is not limited to the above-mentioned number of features. A detailed explanation for performing the steps for generating the graph embedding features based on the BipGNN model 228 is herein explained in detail with reference to FIG. 2 and FIG. 4A, and therefore, they are not reiterated for the sake of brevity.

Referring now to FIG. 5C, a schematic block diagram 560 of a process for calculation of carbon footprint score based on the BIPGNN model 228 is shown. In one embodiment, the processor 206 is configured to access historical transaction data from a transaction database 562. The historical transaction data may include carbon-footprint variables associated with products sold by the merchants.

In one embodiment, the historical transaction data may be fed as an input to the BipGNN model 228. The BipGNN model 228 is configured to generate final node representations of cardholders and merchants. A detailed explanation for performing the steps for generating the embeddings based on the BipGNN model 228 is herein explained in detail with reference to FIG. 2 and FIG. 4A, and therefore, it is not reiterated for the sake of brevity.

In an embodiment, node representations for cardholder nodes and node representations for the merchant nodes obtained from the BipGNN model 228 are fed as an input to a DeepWalk model 564 and a GCN model 566. In general, DeepWalk is an algorithm used to create embeddings of the node in a graph (e.g., the bipartite graph, etc.). The DeepWalk model 564 is configured to generate a first embedding 568. In general, embeddings are meant to encode the community structure of any given graph. In general, GCN is a semi-supervised learning method or approach for graph-structured data. In addition, GCNs are based on convolutional neural networks (CNNs) that directly operate on the graphs (e.g., the bipartite graph, etc.).

The GCN model 566 is configured to generate a second embedding 570. The first embedding 568 generated by the DeepWalk model, and the second embedding 570 generated by the GCN model are fed as inputs to a regressor 572. In general, a regressor is used to find the value of one variable depending upon another variable. In one embodiment, the output of the regressor 572 facilitates the computation of the carbon footprint score. In one embodiment, the output of the regressor 572 provides a suitable prediction for the reduction of the carbon footprint based on the calculated footprint score. In the above-stated downstream application, artificial intelligence techniques and embeddings obtained from the BipGNN model 228 are used to create a carbon footprint profile of the payment card spends. In addition, the carbon footprint scores may be calculated at cardholder level, merchant level, and/or transaction level.

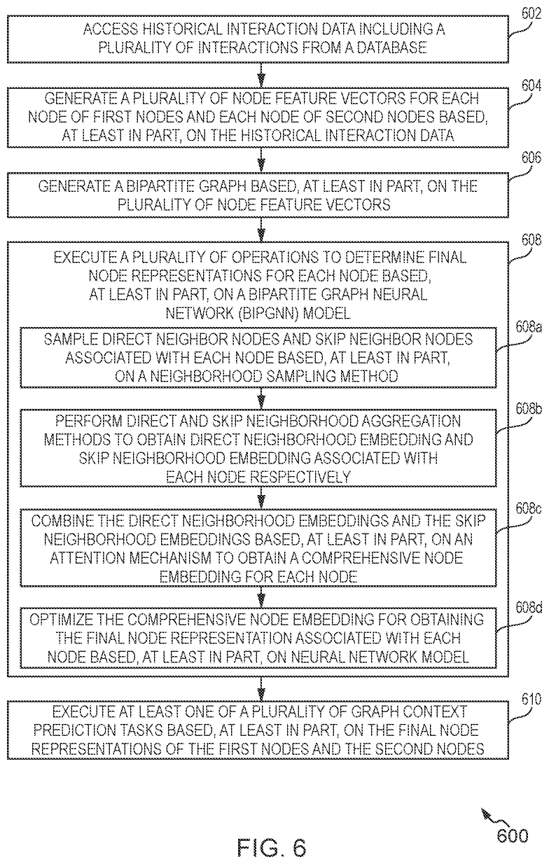

FIG. 6 represents a flow chart 600 of a method for unsupervised representation learning for a bipartite graph including the first set of entities 104a-104c and the second set of entities 106a-106c, in accordance with an embodiment of the present disclosure. The sequence of operations of the flow chart 600 may not be necessarily executed in the same order as they are presented. Further, one or more operations may be grouped and performed in form of a single step, or one operation may have several sub-steps that may be performed in parallel or in a sequential manner. It is to be noted that to explain the flow chart 600, references may be made to elements described in FIG. 1 and FIG. 2.

At 602, the server system 102 accesses historical interaction data including a plurality of interactions from the database 108. The plurality of interactions may be performed between the first set of entities 104a-104c and the second set of entities 106a-106c. In addition, each interaction may be associated with at least one entity of the first set of entities 104a-104c and one entity of the second set of entities 106a-106c.

At 604, the server system 102 generates a plurality of node feature vectors for each node of the first nodes and each node of the second nodes based, at least in part, on the historical interaction data.

At 606, the server system 102 generates the bipartite graph based, at least in part, on the plurality of node feature vectors. The bipartite graph represents a computer-based graph representation of the first set of entities 104a-104c as first nodes and the second set of entities 106a-106c as second nodes and interactions between the first nodes and the second nodes as edges.

At 608, the server system 102 executes the plurality of operations to determine final node representations of the first nodes and the second nodes based, at least in part, on the bipartite graph neural network (BipGNN) model 114. The BipGNN model 114 is a graph neural network (GNN) architecture used to perform representation learning for the bipartite graphs. The plurality of operations is further explained below in steps 608a-608d.

At 608a, the server system 102 samples direct neighbor nodes and skip neighbor nodes associated with each node based, at least in part, on a neighborhood sampling method. In addition, each node may belong to the first nodes or the second nodes. The sampling is performed for each node of the first nodes and each node of the second nodes.

At 608b, the server system 102 executes direct and skip neighborhood aggregation methods to obtain direct neighborhood embedding and skip neighborhood embedding associated with each node respectively.

At 608c, the server system 102 combines/fuses/concatenates the direct neighborhood embedding and the skip neighborhood embedding based, at least in part, on the attention mechanism to obtain the comprehensive node embedding for each node.

At 608d, the server system 102 optimizes the comprehensive node embedding for obtaining the final node representation associated with each node based, at least in part, on the neural network model 230. In this manner, by running steps, 608a-608d for the first nodes and the second nodes, the server system 102 determines the final node representations for the first nodes and the second nodes.

At 610, the server system 102 executes at least one of a plurality of graph context prediction tasks based, at least in part, on the final node representations of the first nodes and the second nodes.

The sequence of steps of the flow chart 600 need not be necessarily executed in the same order as they are presented. Further, one or more operations may be grouped together and performed in form of a single step, or one operation may have several sub-steps that may be performed in parallel or in a sequential manner.

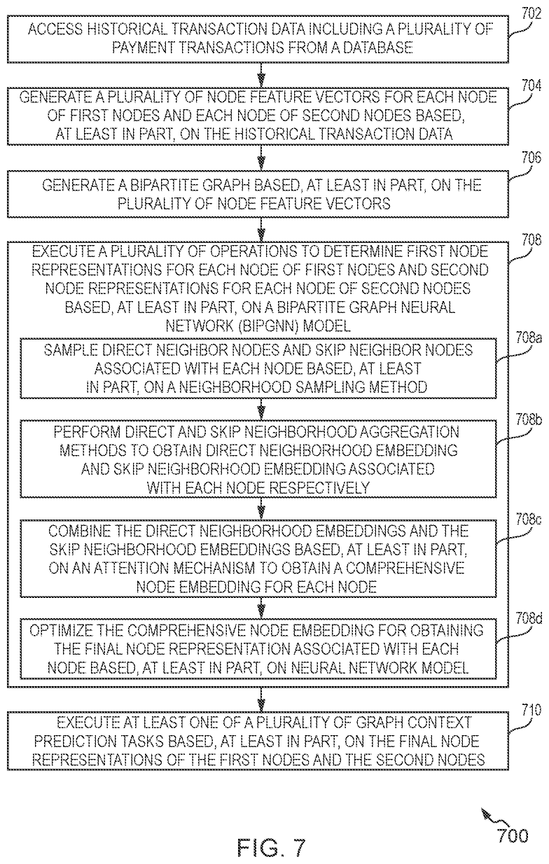

FIG. 7 represents a flow chart 700 of a method for unsupervised representation learning for a bipartite graph including the plurality of cardholders 124a-124c and the plurality of merchants 126a-126c, in accordance with an embodiment of the present disclosure. The sequence of operations of the flow chart 700 may not be necessarily executed in the same order as they are presented. Further, one or more operations may be grouped and performed in form of a single step, or one operation may have several sub-steps that may be performed in parallel or in a sequential manner. It should be noted that to explain the flow chart 700, references may be made to elements described in FIG. 1 and FIG. 2.

At 702, the server system 122 accesses historical transaction data including a plurality of payment transactions from the database 128. The plurality of payment transactions may be performed between the plurality of cardholders 124a-124c and the plurality of merchants 126a-126c. In addition, each payment transaction may be associated with at least one cardholder of the plurality of cardholders 124a-124c and one merchant of the plurality of merchants 126a-126c.

At 704, the server system 122 generates a plurality of node feature vectors for each node of the first nodes and each node of the second nodes based, at least in part, on the historical transaction data.

At 706, the server system 122 generates the bipartite graph based, at least in part, on the plurality of node feature vectors. The bipartite graph represents a computer-based graph representation of the plurality of cardholders 124a-124c as first nodes and the plurality of merchants 126a-126c as second nodes and the payment transactions between the first nodes and the second nodes as edges.

At 708, the server system 122 executes the plurality of operations to determine final node representations for each node of the first nodes and the second nodes based, at least in part, on the bipartite graph neural network (BipGNN) model 142. The BipGNN model 142 is a graph neural network (GNN) architecture used to perform representation learning for the bipartite graphs. The plurality of operations is further explained below in steps 708a-708d.

At 708a, the server system 122 samples direct neighbor nodes and skip neighbor nodes associated with each node based, at least in part, on a neighborhood sampling method. In addition, each node may belong to the first nodes or the second nodes. The sampling is performed for each node of the first nodes and each node of the second nodes.

At 708b, the server system 122 performs or executes direct and skip neighborhood aggregation methods to obtain direct neighborhood embedding and skip neighborhood embedding associated with each node respectively.

At 708c, the server system 122 combines/fuses/concatenates the direct neighborhood embedding and the skip neighborhood embedding based, at least in part, on the attention mechanism to obtain the comprehensive node embedding for each node.

At 708d, the server system 122 optimizes the comprehensive node embedding for obtaining the final node representation associated with each node based, at least in part, on the neural network model 230. In this manner, by running steps, 708a-708d for the first nodes and the second nodes, the server system 122 determines the final node representations for the first nodes and the second nodes.

At 710, the server system 122 executes at least one of a plurality of graph context prediction tasks based, at least in part, on the final node representations of the first nodes and the second nodes. The plurality of graph context prediction tasks may include but are not limited to (1) predicting fraudulent or non-fraudulent payment transactions, (2) calculating an account intelligence score, and (3) calculating a carbon footprint score.

The sequence of steps of the flow chart 700 need not be necessarily executed in the same order as they are presented. Further, one or more operations may be grouped together and performed in form of a single step, or one operation may have several sub-steps that may be performed in parallel or in a sequential manner.

Experiments and Results:

In the experiments, the performance of BipGNN model is compared against state-of-the-art algorithms on different benchmark tasks. An ablation study is also performed by removing individual components of the BipGNN model to assess the effect of each component on the overall performance. This section summarizes the experimental setup, results, and ablation study of the BipGNN model performance.

Experiments can be conducted on three diverse tasks: (1) node classification, (2) node regression, and (3) link prediction.

Datasets:

Four public datasets are used in the evaluation of embodiments: (a) MovieLens (ML), (b) Amazon Movie (AM), (c) Amazon CDs (AC), and (d) Aminer Paper-Author (PA). Details of each data set with the node types, number of nodes, and number of edges used to create the bipartite graph are shown below in the following table.

TABLE 1
Datasets used to evaluate the performance of the BipGNN model

| ML | | AC | | AM | | PA | |
|---|---|---|---|---|---|---|---|
| NODES | EDGES | NODES | EDGES | NODES | EDGES | NODES | EDGES |
| Movie: 1.6K | 100K | CD: 55K | 453K | Movie: 49K | 946K | Paper: 47K | 261K |
| User: 1K | | User: 54K | | User: 44K | | Author: 79K | |

The performance of the BipGNN model is evaluated and compared against other comparative algorithms such as: (1) metapath2vec, (2) Node2Vec, (3) Graph-Sage, (4) Attri2Vec, (5) C-BGNN, and (6) Bine. In addition, F1-score and area under curve (AUC) performance metrics are used to compare the performance of the BipGNN model to perform node classification and link prediction tasks. Alternatively, for the node regression task, performance metrics such as mean squared error (MSE) and mean absolute error (MAE) are used for evaluating the performance of the BipGNN model.

Experiment Settings:

To execute the BipGNN model 228, random walk length is fixed to 8 with the number of walks per node to 8, the neighborhood sample size per layer to 40. The default hidden dimension size is set to 128 for all the algorithms. In addition, 10 epochs are run with a batch size of 512 with a learning rate of 0.0001. Further, paper nodes in the PA dataset are associated with a text (e.g., paper abstract) and the item nodes in AM and AC datasets are associated with a text of title and descriptions. Additionally, The Para2Vec algorithm is used to generate these self-node features (i.e., the plurality of node feature vectors). For user nodes, an average of papers/items features with which they are connected is taken. Moreover, in ML, user nodes are represented through demographics such as occupation, gender, etc. Movies are represented by their genre. Thus, it should be noted that ML is a better representation of a bipartite graph as the features of the two different nodes belong to a separate feature space. All these models are trained on Python 3.7 and Tensorflow 2.3.0. Also, a single Quadro RTX 6000, 16 GB with CUDA 10.1 and cuDNN 7.6.5 is used to implement all these models.

Performance Evaluation:

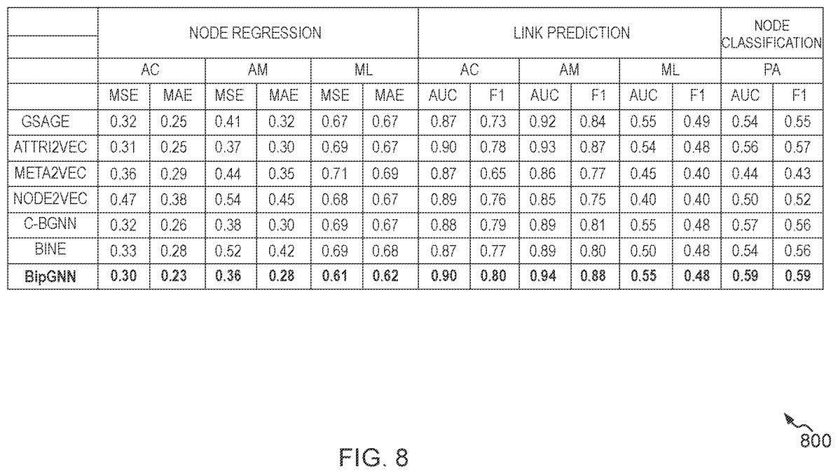

FIG. 8 shows a table 800 including comparative results of the performance of the BipGNN model and the other comparative algorithms on the above-stated plurality of graph context prediction tasks.

Node Regression: To evaluate the performance of the BipGNN model for node regression, three public datasets are used. Here, the aim should predict average ratings of CDs and movies in AC and AM respectively, whereas, for the ML dataset, the age of a user is predicted. Initially, node embeddings are learned in an unsupervised manner and further these embeddings along with the node's self-features are utilized to train a feed-forward neural (FFN) network for the regression task. To perform a fair comparison between the models, the same setting is kept for the FFN network across models i.e., two hidden layers with 128 and 64 neurons, ADAM as an optimizer, and MSE as a loss.

As shown in FIG. 8, the BipGNN model outperforms all other baseline models on all three datasets. The relative improvements (%) over the best baseline range from 1.5% to 10% across different datasets, showing the effectiveness of the node embeddings. It should be noted that a major improvement of around 10% is seen in ML, which is reasonable since the BipGNN model provides extra flexibility for node representations of different node types to lie in a different vector space.

Link Prediction: To evaluate the performance of the BipGNN model for the link prediction task, the same three public datasets are used that were used for the node regression task. Here, the aim should predict whether a link between two nodes exists or not. For the AC dataset, a link between a user and CD denotes that the user has given a rating to a CD Similarly, for AM and ML datasets, a link exists when a user has given a rating to a movie. A random split strategy (90:10) is followed to split the links between the nodes for each dataset. In addition, the training links are used to learn the node embeddings, and further, these node embeddings along with the self-node features are used to train FFN for the binary classification task. The test edges with an equal number of negative samples (non-connected nodes) are used to evaluate the BipGNN model performance. A link embedding is formed by concatenating embeddings of the connected nodes. As shown in FIG. 8, in link prediction, the BipGNN model shows an improvement of 10% in F1-score for AC and an improvement of 1% for AM which can be attributed to enrich embeddings.

Node classification: To evaluate the performance of the BipGNN model 228 for node classification, the PA dataset is used. In addition, a subset of papers that have been published in the top 10 venues is chosen. Here, the aim should predict the venue of a paper. Similar to prior tasks, the node embeddings are learned in an unsupervised manner, and further, the FFN network is trained by concatenating the generated node embeddings and node's self-feature vectors to classify the node into ten class classification problems.

As shown in FIG. 8, the BipGNN model outperforms the state-of-the-art baseline models with a performance boost of around 5.29% in terms of accuracy and a 4.21% performance boost in terms of F1-score.

Analysis and Discussion:

Ablation Study: The BipGNN model consists of three main components: (1) the neighborhood sampling method, (2) skip neighbor nodes with the attention mechanism, and (3) mutual information (MI) maximization loss value. In one experiment, the performance of the BipGNN model is studied after the removal of these individual components. The experiment is performed on the ML dataset for the task of node regression, where the aim should predict the age of a user. The values of MAE and MSE for the ablation study are illustrated below in Table 2:

TABLE 2
Ablation study

| | | No | No skip neighbor | No MI |
|---|---|---|---|---|
| | BIPGNN | neighborhood | nodes with an | maximization |
| | model | sampling | attention mechanism | loss value |
| MAE | 0.62 | 0.65 | 0.63 | 0.64 |
| MSE | 0.61 | 0.68 | 0.63 | 0.65 |

The table 2 shows the comparison of MAE and MSE after removal of individual components and it can be observed that, in each of the three scenarios, performance is always lower as compared to the BipGNN model. In addition, removal of the neighborhood sampling and the MI maximization loss has a significant impact (around 8% and 13% respectively) on the performance, while removal of the skip neighbor nodes results in a relatively modest (around 3%) performance drop.

Enriched Representation Learning: As stated above, the BipGNN model is configured to learn the node representations that directly capture the information from the neighbor nodes and indirectly capture the information from the self-node features. In general, most of the comparative algorithms use features of a node directly as one of the inputs to learn the node representations and thereby end up learning correlated information. An experiment is performed to see the correlation between the errors of downstream models: (1) Model-1: FFN using only node's self-features, and (2) Model-2: FFN using only graph embeddings.

To perform this experiment, the ML dataset is used where the aim should predict the average rating of a movie. The following table shows the comparison of Pearson correlation between errors of Model-1 and Model-2 for all the comparative algorithms.

TABLE 3

| | | | Graph- | | C- | | BIPGNN | |
|---|---|---|---|---|---|---|---|---|
| Algorithm | Attri2vec | Meta2vec | SAGE | Node2vec | BGNN | Bine | (No MI) | BipGNN |
| ρ | 0.964 | 0.819 | 0.959 | 0.821 | 0.914 | 0.770 | 0.790 | 0.847 |
| MSE | 0.741 | 1.02 | 0.679 | 0.990 | 0.761 | 0.998 | 0.831 | 0.689 |

The observations obtained from the table 3 are as follows:

Observation 1: GraphSAGE (correlation value=0.959) and Attri2Vec (correlation value=0.964) show a very high correlation between the errors of Model-1 and Model-2 since both algorithms use the self-node features as an input to learn the node representations which indicates that learned node representation and the self-node features essentially capture the same information.

Observation 2: Meta2Vec (correlation value=0.819), Node2vec (correlation value=0.821), and Bine (correlation value=0.770) have the least correlation among other algorithms, indicating that these representations have information that does not significantly overlap with the self-node features, but their performance in downstream tasks is unfortunately subpar.

Observation 3: The BipGNN model (correlation value=0.847) has a significantly lower correlation as compared to feature-based approaches (e.g., GraphSAGE, Attri2Vec, etc.) and a solid performance boost in the downstream tasks. Since the BipGNN model does not explicitly use the self-node features but implicitly captures the self-information (i.e., using the MI loss value), the BipGNN model can generate final node representations that not only perform well independently but also have a low overlap with the self-node features. Hence, when the final node representations and the self-node features are combined, they result in an even better performance.

Observation 4: The observation 4 is related to the contribution of the MI loss value. With the removal of the MI maximization loss value from the BipGNN model, the correlation value falls significantly implying more complimentary information between the node representation and the self-node features, however, a drop in the model performance is also observed.

Embodiments of the present disclosure provide for a number of advantages. For example, experimental results on a number of graph datasets indicate a significant margin of gains over several recently proposed methods. The evaluation results show that embodiments of the present disclosure achieve significant improvements over several state-of-the-art baselines and maintain a more stable performance in learning node representations for bipartite graphs that directly captures both direct and skip relations between the nodes.

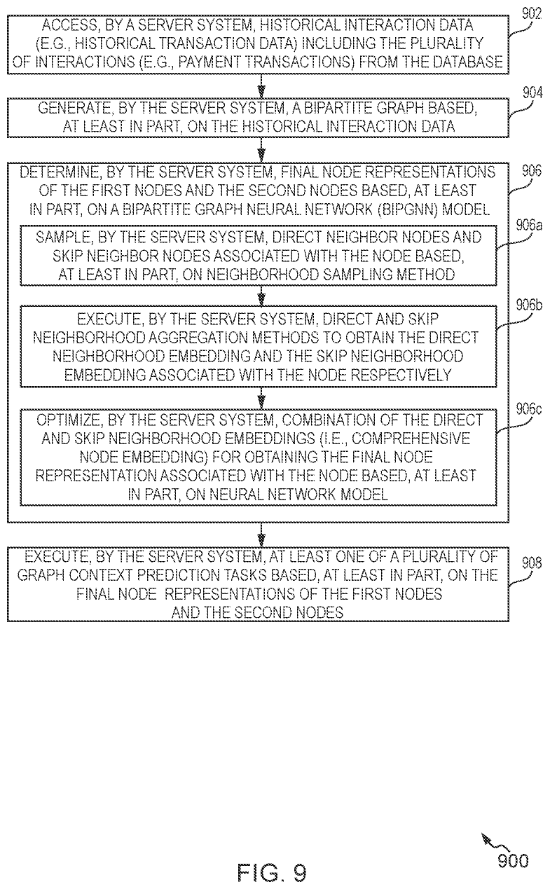

FIG. 9 illustrates a flow diagram depicting a method 900 for representation learning for bipartite graphs, in accordance with an embodiment of the present disclosure. The method 900 depicted in the flow diagram may be executed by, for example, the server system 200. Operations of the method 900, and combinations of operation in the method 900, may be implemented by, for example, hardware, firmware, a processor, circuitry, and/or a different device associated with the execution of software that includes one or more computer program instructions. The operations of the method 900 are described herein may be performed by an application interface that is hosted and managed with help of the server system 200. The method 900 starts at operation 902.

At operation 902, the method 900 includes accessing, by the server system 200, historical interaction data (e.g., historical transaction data) including the plurality of interactions (e.g., payment transactions) from the database (e.g., the database 108 or the database 128). Each interaction is associated with at least one entity of the first set of entities 104a-104c (e.g., the plurality of cardholders 124a-124c) and one entity of the second set of entities 106a-106c (e.g., the plurality of merchants 126a-126c).

At operation 904, the method 900 includes generating, by the server system 200, the bipartite graph based, at least in part, on the historical interaction data. The bipartite graph represents a computer-based graph representation of the first set of entities 104a-104c (e.g., the plurality of cardholders 124a-124c) as first nodes and the second set of entities 106a-106c (e.g., the plurality of merchants 126a-126c) as second nodes and interactions between the first nodes and the second nodes as edges.

At operation 906, the method 900 includes determining, by the server system 200, the final node representations of the first nodes and the second nodes based, at least in part, on the bipartite graph neural network (BipGNN) model 228. The final node representations are determined by executing a plurality of operations for each node in graph traversal manner. The plurality of operations is depicted in operations 906a-906c.

At operation 906a, the method 900 includes sampling, by the server system 200, the direct neighbor nodes and the skip neighbor nodes associated with the node based, at least in part, on the neighborhood sampling method.

At operation 906b, the method 900 includes executing the direct and skip neighborhood aggregation methods to obtain the direct neighborhood embedding and the skip neighborhood embedding associated with the node respectively.

At operation 906c, the method 900 includes optimizing, by the server system 200, the combination of the direct and skip neighborhood embeddings (i.e., the comprehensive node embedding) for obtaining the final node representation associated with the node based, at least in part, on the neural network model (i.e., a decoder model 230).

At operation 908, the method 900 includes executing at least one of a plurality of graph context prediction tasks based, at least in part, on the final node representations of the first nodes and the second nodes by concatenating the final node representations with corresponding self-node features.

The sequence of operations of the method 900 need not be necessarily executed in the same order as they are presented. Further, one or more operations may be grouped together and performed in form of a single step, or one operation may have several sub-steps that may be performed in parallel or in a sequential manner.

The disclosed methods with reference to FIGS. 1A to 9, or one or more operations of the methods 600, 700, and 900 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, netbook, Web-book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad spirit and scope of the disclosure. For example, the various operations, blocks, etc. described herein may be enabled and operated using hardware circuitry (for example, complementary metal-oxide-semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or in Digital Signal Processor (DSP) circuitry).

Particularly, the server system 200 (e.g., the server system 102 or the server system 122) and its various components such as the computer system 202 and the database 204 may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or computer to perform one or more operations. A computer-readable medium storing, embodying, or encoded with a computer program, or similar language may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g., magneto-optical disks), CD-ROM (compact disc read-only memory), CD-R (compact disc recordable), CD-RAY (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

We claim:

1. A computer-implemented method, comprising:
accessing, by a server system, historical interaction data comprising a plurality of interactions from a database, each interaction associated with an entity of a first set of entities and at least one entity of a second set of entities;
generating, by the server system, a bipartite graph based, at least in part, on the historical interaction data, the bipartite graph representing a computer-based graph representation of the first set of entities as first nodes and the second set of entities as second nodes and interactions between the first nodes and the second nodes as edges;
determining, by the server system, final node representations of the first nodes and the second nodes based, at least in part, on a bipartite graph neural network (BipGNN) model, the final node representations determined by executing a plurality of operations for each node in graph traversal manner, the plurality of operations comprising:
sampling, by the server system, direct neighbor nodes and skip neighbor nodes associated with a node based, at least in part, on a neighborhood sampling method;
executing, by the server system, direct and skip neighborhood aggregation methods to obtain direct neighborhood embedding and skip neighborhood embedding associated with the node, respectively; and
optimizing, by the server system, a combination of the direct and skip neighborhood embeddings for obtaining a final node representation associated with the node based, at least in part, on a neural network model; and
executing, by the server system, at least one of a plurality of graph context prediction tasks based, at least in part, on the final node representations of the first nodes and the second nodes.

2. The computer-implemented method as claimed in claim 1, wherein the neighborhood sampling method defines a probability function that is proportional to a strength of weighted edge between a neighboring node and the node.

3. The computer-implemented method as claimed in claim 1, wherein the plurality of operations further comprises:
combining, by the server system, the direct and skip neighborhood embeddings of the node to generate a comprehensive node embedding associated with the node based, at least in part, on an attention mechanism.

4. The computer-implemented method as claimed in claim 3, wherein the attention mechanism defines attention weights of the direct and skip neighborhood embeddings of the node based, at least in part, on corresponding correlation values of the direct and skip neighborhood embeddings with self-node features of the node.

5. The computer-implemented method as claimed in claim 4, wherein the neural network model represents a decoder model that is configured to maximize mutual information between the comprehensive node embedding and the self-node features of the node.

6. The computer-implemented method as claimed in claim 5, wherein the BipGNN model comprises a plurality of graph neural networks and the decoder model, and wherein the BipGNN model is trained based, at least in part, on a combination of a first loss value and a second loss value.

7. The computer-implemented method as claimed in claim 6, wherein the first loss value preserves mutual information between the comprehensive node embedding and the self-node features of the node, and wherein the second loss value preserves graph structure of the bipartite graph.

8. The computer-implemented method as claimed in claim 1, wherein the first set of entities represents a plurality of merchants and the second set of entities represents a plurality of cardholders who have performed at least one payment transaction with at least one of the plurality of merchants.

9. The computer-implemented method as claimed in claim 1, wherein the plurality of graph context prediction tasks comprises at least one of: (a) predict fraudulent or non-fraudulent payment transactions, (b) calculate an account intelligence score, and (c) calculate a carbon footprint score.

10. A server system configured to perform the computer-implemented method as claimed in claim 1.
